(19) United States
(12) Patent Application Publication
(10) Pub. No.: US 2023/0306213 A1
(43) Pub. Date: Sep. 28, 2023

(54) METHOD, PLATFORM, AND SYSTEM OF ELECTROMAGNETIC MARKING OF OBJECTS AND ENVIRONMENTS FOR AUGMENTED REALITY

(71) Applicant: Atheraxon, Inc., Atlanta, GA (US)

(72) Inventor: Jimmy Hester, Atlanta, GA (US)

(21) Appl. No.: 18/190,965

(22) Filed: Mar. 27, 2023

Related U.S. Application Data
(60) Provisional application No. 63/323,642, filed on Mar. 25, 2022.

(51) Int. Cl. G06K 19/077; G06K 7/10

(52) U.S. Cl. CPC G06K 7/10366; G06K 19/07773

(57) ABSTRACT

The present platform allows for real-time, accurate situational awareness to an augmented reality (AR) system while using low power, low-maintenance wireless tags. In one aspect, the platform may comprise devices, methods, and systems for providing a visual indication associated with an electromagnetic tag associated with a target object in a physical environment, such as inventory in a warehouse or retail environment. The platform may include a portable electronic device comprising a display, a processing unit, and a radar unit; and at least one wireless tag. The platform may be configured to receive information signals from at least one wireless tag attached to at least one target object in a physical environment of a user, and generate a visual indication associated with the tagged target object based at least on the received information signals, said visual indication at least having information corresponding to the object’s location or position.

### RELATED APPLICATIONS

The application claims the benefit of priority to U.S. Provisional App. Ser. No. 63/323,642, filed March 25, 202, which is hereby incorporated in its entirety.

### FIELD OF DISCLOSURE

The present disclosure generally relates to visual localization of electromagnetically tagged objects for augmented reality.

### BACKGROUND

Recent trends in the dramatic increase of E-commerce as a share of total retail sales-expected to reach 21.8%, up from 7.4% in 2015-and the increasing difficulty of finding qualified, reliable, and stable labor in industries related to order-fulfilment-related activities have brough to the forefront the need to accelerate the training and enhance the performance of such workers. More specifically, storers and pickers in warehousing and retail environments are required to gather items at high speed in large and often complex environments. These are usually equipped with display-equipped barcode scanning guns. These provide basic information on the area in which the next item to pick is located-which requires broad prior knowledge of the environment-along what can be obscure details (a long number and, sometime, a small image) about the specific item to be picked. This last step is often confusing and time consuming since many nearby items can visually look nearly identical and because their precise location on a shelf cannot be effectively communicated.

Virtual reality (VR) and augmented reality (AR) systems offer the opportunity to provide the user of such devices with artificial sensory (usually visual) cues designed to enhance their perception of their environment beyond their natural abilities. This process, therefore, requires three main steps: 1) acquisition of the relevant environmental information; 2) translation of this information into a synthetic cue subjectively relevant to the user, which can involve the fusion of this environmental information with external data (originating from a central server, for instance); and 3) transmission of this cue to the user.

Wireless devices or sensors that are not worn by the user-and, therefore, not constrained by the requirements of embedded and wearable systems-can readily acquire large amounts of high-dimensionality data about an environment. However, the translation of this information into a sensory cue that can readily be understood by a user requires an almost impossibly accurate real-time knowledge of the user’s sensory inputs. For this reason, such sensing systems almost invariably involve a significant wearable component.

Our most acute sense is vision and it is, therefore, the most attractive input to communicate a signal to the user through. However, its complexity is such that computer vision systems (especially wearable ones) struggle to match even any of its basic capabilities in both accuracy and speed. AR/VR systems can be made aware of their environment through either a centralized environment-tracking system or using local measurements. Systems using centralized environments often require the combined tracking of the items/landmarks of interest and of the 6-axis position of the AR/VR device, the expression of the position of the items in the local coordinate system of the AR/VR device, and its communication in real-time to the device. Centralized systems generally require both consistent ultra-low-latency communications and the ability to (in real-time) acquire the accurate 6-axis position of the AR/VR device. These two challenges are, on their own, nearly insurmountable in most conditions. The 6-axis position problem alone has been a longstanding issue for VR systems and has been partially tackled (at great cost) with dedicated onboard processing by specialized hardware. Systems may use local measurements where they are sufficient to enable the situational awareness of the AR/VR device, but generally do not rely on low-latency communications with a central system.

Optical technologies require large amounts of computational power to identify even basic items (even for light algorithms such as YOLO), due to the complexity of real-time image processing. It is difficult for such systems to recognize and locate anything, let alone small items or optically non-discernible entities (apparently identical positions on shelves, or identically looking items, for instance). Specific identities may be determined using large barcodes or QR codes at close enough range and with high enough resolution cameras. Nevertheless, most VR/AR systems rely heavily on worn point-of-view cameras, coupled with embedded image processing computational systems. This results in systems which, in order to provide even marginally interesting capabilities in a reasonable form factor and for a mere handful of operating hours, require expensive bulky computational units and large battery packs, or tethering. Furthermore, these cameras are only capable of providing very limited suprasensory capacities by slightly extending the spectral range of traditional human vision. Therefore, camera-based AR systems have very little understanding of their environment. Even their combination with infrared tags is impractical because these IR emitters consume large amounts of power, do not enable ranges over a few meters and, therefore, cannot be widely deployed at low cost.

Another option is to completely or almost entirely do without requiring the use of cameras. However, this can only be accomplished using wireless devices or sensors whose measurements space can straightforwardly relate to visual parameters. More explicitly, our visual system determines brightness, spectral information (colors), and depth (poorly beyond a few meters). All of these pieces of information are displayed to us over a 2D (azimuth and elevation) angular field. As a consequence, wireless devices or sensors capable of measuring parameters over a 2D angular space with coordinates closely matching that of our visual system may suited for such implementations.

To this end, a wireless system can potentially determine the presence and location of wireless devices or sensors placed in relevant locations. These wireless devices or sensors are predominantly of the active type, with the only significant exception to this being passive radio frequency identification (RFIDs). Existing passive RFID systems, which rely on low frequency devices, are unable to offer the localization accuracies required by AR systems, nor are they amenable to compact wearable implementations. Active devices require active transceivers and, therefore, are expensive, complex, and power consuming. Furthermore, their use at frequencies higher than 5.8 GHz becomes gradually more expensive and, therefore, much more marginal.

Accordingly, there remains a need for improved methods and systems for visual localization of object within using low-power, ultra-thin wireless tag capable of being wrapped around any material without compromising their radiation performance and providing real-time, accurate situational awareness to an AR device while consuming little power and without requiring the constant maintenance of the tags. This need and other needs are met by the various aspects of the present disclosure.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter’s scope.

According to various aspects, the present platform allows for detection of electromagnetically tagged objects within an environment, and visual localization of the target object in the visual field of a platform user, for example, through an electronic device, such as a portable viewing device, for example a radar-enhanced AR headset. In further aspects, the present platform can significantly accelerate the essential steps of the picking process by overlaying position indicators, in real time, in the visual field of the wearer of a radar-enhanced augmented reality headset.

In one aspect, embodiments of the present disclosure provide a system for detecting and providing a visual indication associated with an electromagnetic tag, such as radio frequency identification (RFID), in a physical environment of a user, such as a worker in a warehousing or retail environment. In a further aspect, the system may comprise a portable electronic device comprising a display, a processing unit, and a radar unit; and at least one wireless tag. In a still further aspect, the system may be configured to receive information signals from at least one wireless tag attached to at least one target object or location (e.g., a particular part or a particular shelf/bin location, etc.) in a physical environment of a user, and generate a visual indication associated with the tagged target object or target location based at least on the received information signals.

In another aspect, embodiments of the present disclosure provide a method comprising one or more of:
designating at least one wireless tag associated with a target object for detection from among a plurality of tagged objects within an environment;
analyzing the environment for the at least one tagged target object;
detecting the at least one tagged target object within the environment;
determining a direction and/or location for locating the at least one tagged target object; and
transmitting the direction and/or location of the at least one tagged target object.

In a further aspect, designating at least one tagged target object for detection may comprise activating a wireless tag on the at least one tagged target object and/or communicating information about the at least one tagged target object. In a still further aspect, detecting may comprise receiving information signals from the at least one tagged target object. In a yet further aspect, transmitting may comprise displaying the direction and/or location as an overlay on a display of the user. In an even further aspect, the method may comprise deactivating the wireless tag on the at least one tagged target object.

In yet another aspect, embodiments of the present disclosure may further provide a non-transitory computer readable medium comprising a set of instructions which when executed by a computer perform a method, the method comprising one or more of:
designating at least one wireless tag associated with a target object for detection from among a plurality of tagged objects within an environment;
analyzing the environment for the at least one tagged target object;
detecting the at least one tagged target object within the environment;
determining a direction and/or location for locating the at least one tagged target object; and
transmitting the direction and/or location of the at least one tagged target object.

In a further aspect, designating at least one tagged target object for detection may comprise activating a wireless tag on the at least one tagged target object and/or communicating information about the at least one tagged target object. In a still further aspect, detecting may comprise receiving information signals from the at least one tagged target object. In a yet further aspect, transmitting may comprise displaying the direction and/or location as an overlay on a display of the user. In an even further aspect, the method may comprise deactivating the wireless tag on the at least one tagged target object.

In another aspect, embodiments of the present disclosure may provide a method for efficient identification and localization of a wireless tag associated with a target object within an environment. The method may begin with receiving a target wireless tag or tagged target object selection from a selection source, the selection source comprising at least one of the following: a central server or database, or the like. The selection may include at least one target object, such as product or good, that may be designated for detection and/or localization within the environment, for example, to be picked by a worker. In some embodiments, a target object profile associated with a designated target object or object category, which comprises information about the target object identity or target object location may be retrieved from a database of target object profiles. In other embodiments, a wireless tag associated with the designated target object may be activated to enable detection and/or localization. Upon activation, wireless tag may be detected and a direction and/or location may be determined and visually indicated to the user. Because of employment of much higher frequencies, the present platform can combine modern mm-wave radar technologies (consistently used for the imaging of passive targets) with backscatter concepts to generate radar cross section (RCS) signatures (using ultra-low-power tags) that greatly increase the capabilities of radar systems. That is, the present platform can create recognizable patterns that are easily identified and localized by the radar system. In this way, the platform allows for efficient and reliable marking of entire environments (including most of the objects that inhabit them) with tags with little maintenance requirements (e.g., decades-long battery lives or powered through ambient energy).

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment for the platform consistent with the present disclosure.

FIG. 2A shows a diagram of a wireless tag for visual localization in accordance with the disclosed platform.

FIG. 2B shows a diagram of a wireless tag for visual localization in accordance with the disclosed platform.

FIG. 2C shows a diagram of a wireless tag for visual localization in accordance with the disclosed platform.

FIG. 3 shows a diagram of a mobile AR viewing device for visual localization in accordance with the disclosed platform.

FIG. 4 shows a diagram of a localization engine of a mobile AR viewing device for visual localization in accordance with the disclosed platform.

FIG. 5A is a graph showing measured range between the mobile AR viewing device and wireless tag for visual localization in accordance with the disclosed platform.

FIG. 5B is a graph showing measured range between the mobile AR viewing device and wireless tag for visual localization in accordance with the disclosed platform.

FIG. 6 illustrates a block diagram of a visual indication output of the platform consistent with the present disclosure.

FIG. 7 illustrates a block diagram of a 6 Degrees Of Freedom (6DOF) localization consistent with the present disclosure.

FIG. 8A shows a depiction of a method for visual localization of a target tag in accordance with the disclosed platform.

FIG. 8B shows a depiction of a method for visual localization of a target tag in accordance with the disclosed platform.

FIG. 9 is a block diagram of a system including a computing device for use with the platform.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Regarding applicability of 35 U.S.C. §112, 46, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present platform allows for low maintenance electromagnetic marking of objects and environments for radar-enabled augmented reality applications. The platform enables an electronic device such as a portable viewing device, for example, an AR headset or handheld scanner, to detect wireless tags associated with a target object and provide a visual indication associated with the tag on the device. The disclosed wireless tags may be ultra-low power, high frequency, and employ an extremely power-frugal backscatter communications scheme, which can readily communicate data and/or create a recognizable electromagnetic signature using power levels as low 10 uW, or lower. Furthermore, the disclosed wireless tags can display extended reading ranges and ultra-thin form factors. The disclosed wireless tags can run for more than a decade, even under heavy use. Furthermore, the wireless tags can be made ultra-thin and wrapped around any material without compromising their radiation performance, unlike RFID (whose performance degrades heavily in the presence of metal).

The disclosed electronic devices, which are enabled to detect the specific wireless signal from the wireless tag, may use information from the detected signal and various localization techniques to determine the relative position, and/or location of the wireless tag (and thus object or item of interest attached thereto). Still further, the disclosed wireless tags may use frequencies of common radar systems in the ISM bands (e.g., such as in the 24-24.25 GHz band) and can allow the use of low-cost FMCW systems as interrogators in the electronic locating device, which naturally provide accurate localization abilities in both range and angular spaces. Consequently, the platform enables portable electronic devices with radar readers and systems mounted onto a wearable headset and ultra-low-power sticker-like backscatter wireless tags operating at frequencies in excess of 24 GHz as an alternative to the existing active wireless tag approaches. This allows a portable, small form factor, lightweight, viewing device capable of measuring angles of arrivals (AoAs) with better than a few degrees of accuracy while consuming less than 100 mW of power. In this way, the platform enables real-time, accurate situational awareness to an AR system while consuming little power and without requiring the constant maintenance of the wireless tags that enable it. Furthermore, with the employment of compact mm-wave radar imagers (which can, in various aspects, be small enough to fit on a single chip: SOLI), the present platform will enable AR systems with situational awareness orders-of-magnitude greater than what is currently possible.

The present disclosure includes many aspects and features. Moreover, while many aspects and features relate to, and are described in, the context of a platform for detection and localization of wireless tags in warehouse and retail environments using AR devices, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter’s scope. According to various aspects, the present methods, techniques, systems, devices and a computer readable medium (collectively referred to herein as the “platform”) provide for detection of electromagnetically tagged objects or landmarks within an environment, and visual localization of the target object in the visual field of a platform user, for example, through an electronic device, such as a portable viewing device, for example a radar-enhanced AR headset or handheld scanner.

In further aspects, embodiments of the platform employ a wireless device or sensor, such as a wireless tag or label, that can be coupled or attached to a target object or item of interest within an environment, such as inventory within a warehouse or retail environment, in order to physically and/or geographically locate it using wireless communications systems and techniques. The electronic device, which is enabled to detect the specific wireless signal from the wireless tag, may then use information from the detected signal and various localization techniques to determine the relative position, and/or geolocation of the wireless tag (and thus the object of interest attached or associated thereto).

In various aspects, wireless tags may be active or passive. On one hand, systems using active transmission can put a heavy energetic burden on the tags (which need to regularly generate and emit wireless signals) which, consequently, lead to low battery lives, especially in contexts of heavy use. Furthermore-due to the lack of appropriately-accurate time synchronization between wireless tags and the electronic device necessary for accurate ranging-several back-and-forth communication cycles between the tags and the electronic device may be required to determine the range, thereby further increasing the power consumption of the wireless tags. Ultrawide band (UWB) wireless technology, while capable of providing the cm-dm accuracy necessary for the empowerment of VR systems, is known to be power intensive. Due to the large energy consumption required by these active tags, these systems are more useful for the localization of a few important assets for which tag batteries are worth replacing every few months (e.g., keys). However, these active tags are inadequate for applications that require the use of the hundreds or thousands of tags required to mark an environment (like warehouse or retail shelves), for interactions with items whose owners do not have in their immediate custody (pallets, containers, etc.), or for low-cost items not worth maintaining (books on a shelf, boxes, etc.). Therefore, these active tags are limited to tracking specific items rather than to serving as massively deployed general markers of an environment.

On another hand, conventional passive tags, which are commonly referred to as radio frequency identification (RFID) tags or RFIDs, that rely on low-frequency are generally unable to offer the localization accuracies required by AR systems, nor are they amenable to compact wearable implementations. For example, given that at least three antennas are generally needed to determine a 3D position (range, azimuth, elevation), their antenna systems have to be at least about 30 cm x 30 cm in size at 900 MHz. Furthermore, the propagation properties at these frequencies (along with the small amount of available bandwidth in the 900 MHz band) are not understood to allow localization accuracies of better than 1-2 m. These low-frequency tags are generally contingent upon the existing 900 MHz RFID standards based on the belief that higher frequencies lead to shorter ranges. At the typical spacing of half a wavelength needed between elements and antennas of a quarter of a wavelength in size, UHF RFID (900 MHz), BLE (2.4 GHz), UWB (8 GHz) devices generally require array sizes of about 33 cm x 33 cm, 12.5 cm x 12.5 cm, and 3.8 cm x 3.8 cm to even begin to provide 2D angular information.

Significantly, embodiments of the present platform overcome the challenges of the prior art by using combinations of ultra-low-power wireless tags, higher frequencies, and mm-wave radar technologies with backscatter concepts. In further aspects, the platform can generate radar cross section (RCS) signatures that greatly increase the capabilities of radar systems. In still further aspects, the platform can thus create recognizable patterns that are easily identified and localized by a radar system, such as those in the AR devices of the present disclosure. Accordingly, the platform allows for extended reading ranges compared to alternatives operating at lower frequencies while still allowing for the use of small form factor, lightweight, low-cost portable devices for detecting and presenting the visual localization and information associated with the target tag to the end user.

As described herein, a wireless tag of the present platform used for detecting and locating physical objects may be a thin, ultra-low powered device that can be easily manufactured and can be coupled to or next to objects or landmarks in various environments, such as to goods and products or product bins and shelves in a warehouse or retail environment, to help a worker visually locate goods. The wireless tag may include a structural design that has a relatively long range and experiences minimal signal loss to ensure efficient and reliable use on various object geometries and in a variety of environments. For example, the wireless tag may be a thin label, experiences minimal signal loss when applied to curved surfaces, and may be capable of decades of normal use without the need for maintenance or to replace tag batteries. In some embodiments, the long product life and low maintenance requirements of the wireless tag may be facilitated by the absence of some components, such as those that may require replacement, for example, replaceable tag batteries, external parts, and the like. In various further aspects, the wireless tag may include a specialized wireless communication system and circuitry that employ a power-frugal communications scheme. Localization functions may be provided by the wireless communication system, and in particular, by the tag wireless sending a recognizable electromagnetic signature to other devices (e.g., AR headset, handheld scanner tablet computers, etc.) that detect and analyze these wireless signals to determine the distance, position, location, and/or orientation of the wireless tag with a high degree of accuracy. As used herein, the terms “localize” or “localization” refers to determining one or more spatial parameters of a wireless tag or device. In further aspects, spatial parameters may include parameters of an object that define an aspect of its distance, position, location, and/or orientation in absolute space or relative to another object. For example, spatial parameters may include parameters such as a distance between objects, a location in a particular geography (e.g., coordinates), a unit vector pointing from one object to another object, an orientation (also referred to as an angular position or attitude) of an object in three-dimensional space, or the like. In still further aspects,

In further aspects, a wireless tag in accordance with the platform may comprise an antenna system comprising one or more antennas. The antenna system may receive a querying signal and use some of the energy in the signal to generate a response signal that is detectable and localizable by wireless-enabled (e.g., radar) electronic viewing device, such as an AR headset or handheld scanner, or the like. The response signal may have information such as a unique identification or the like modulated thereon. In some embodiments, the antenna system may comprise individual antennas, instead of linear arrays, for example, to make the system more compact. In other embodiments, the antenna system may comprise a 2D array of individual antennas, for example, and without limitation, 2D individual antenna arrays as taught in US6657580, which is herein incorporated by reference for its teaching of 2D arrays. In still further aspects, the antenna system may comprise a retrodirective array. By way of non-limiting example, the antenna system may be generally comprised of a cross-polarizing retrodirective antenna array effective to allow the detection of the tags at extended ranges. Such antenna systems are taught in US10511100, which is herein incorporated by reference for its teaching of printed antenna arrays. In even further aspects, the antenna system may be configured to re-emit at least a portion of impinging signals back in a polarization state that is orthogonal to that of an original signal. In yet further aspects, the wireless tag does not generate any or substantially no electromagnetic wave to enable its localization.

In further aspects, the wireless tag may comprise a front-end system comprising one or more phase-shifters and/or switches configured to modulate phase and magnitude of a backscattered signal. In some aspects, the wireless may comprise a high-frequency, backscatter front-end system comprising an antenna system and/or switches. In still further aspects, the wireless tag is configured to use a frequency higher than the 900 MHz ISM band, greater than 5.8 GHz, greater than 8 GHz, such as a frequency equal to or greater than 24 GHz. In yet further aspects, the wireless tag may comprise an ultra-low-power modulator circuit configured to control the front-end system effective to shape the backscattered signal. The switches may be configured to be controlled by a modulator which, in some aspects, can be a low-power processor/ASIC/FPGA or an ultra-low-power timer/oscillator controlled by a processor/ASIC/FPGA, or the like. The modulator circuit may comprise an ultra-low-power timer operating at a frequency between about 100 Hz and about 10 MHz, and any subranges therein. In even further aspects, modulation of the switches may be configured to allow the wireless tag to modulate a radar cross section (RCS) effective to create a recognizable synthetic signature for the radar of the locating or viewing device.

In further aspects, the wireless tag may comprise at least one ultra-low-power computational unit or processing unit. The computational unit may be configured to also serve as a modulator. In still further aspects, the wireless tag may comprise at least one of: a battery, a circuit enabling wireless powering, or an energy-harvesting circuit, or combinations thereof, or the like. In some embodiments, the wireless tag may comprise a battery or supercapacitor, or similar power source. In other embodiments, the wireless tag may comprise an energy harvesting system comprising a solar cell or another converter of ambient energy, or the like.

In yet other embodiments, the wireless tag may comprise a display for displaying information normally found on a product label, for example, a low power display such as an E-ink display for use as a standard label. Accordingly, various embodiments of the wireless tag may be configured to substitute or complement traditional product labels, for example, at the picking position/bin associated with each object or item. In still further aspects, the wireless tag may comprise a wireless transceiver. The wireless transceiver may comprise an active wireless transceiver configured to reprogram the tag. The wireless transceiver may employ any desired wireless communication standards including but not limited to Wi-Fi, Bluetooth™, Bluetooth™ Low Energy (BLE), or near field communication (NFC), or the like. In yet further aspects, the wireless transceiver may be configured for wireless communication without involvement in a localization process. In even further aspects, the wireless communication may be with a central server or databases, or to, for example, allow for the wireless tag to be reprogrammed or send communicate the status of the wireless tag.

In further aspects, the wireless tag may be configured to operate in a number of different modes. For example, the wireless tag may be configured to be continuously left ON or NOT. In still further aspects, the wireless tag may operate in a dormant mode without communicating with other devices to conserve power and/or intermittently communicating with one or more other devices. The communications may function to confirm the location and may exchange some information about the state or location of the wireless tag. In this way, the tag can update other devices on the platform, such as the central server, with its location and/or status. In some embodiments, a communication from the wireless tag may be one-way communications, such as sending a wireless signal for other devices to receive, but not receiving any information from the other devices. In further aspects, the wireless tag may receive communication configured to reprogram the wireless tag.

In yet further aspects, the wireless tag may operate in an operating mode. The operating mode may be triggered in response to a communication from one or more other devices on the platform (e.g., the user’s device, central server, a base station, or server, or the like), which may activate the wireless tag to begin communicating a signal for detection and localization by the AR device of the user. Upon locating or other event (e.g., recognition by the platform or an input or gesture by the user indicating the object has been located or task completed), another communication may be transmitted to the target wireless tag to terminate operating mode and turn off signal communication. The wireless tag may be configured not to be left continuously on. In such embodiments, the wireless tag of interest which need to be localized may be configured to be wirelessly instructed to turn ON their RCS modulation. In further aspects, the tag modulation may be configured to occur at an assigned frequency (FM), which is associated with the tag. In still further aspects, the wireless tag modulation may be configured to be on for a predetermined period, for example, for a period effective to allow its detection and identification by the user. In some embodiments, the wireless tag may comprise a RX antenna, a TX antenna, a line connecting the antennas with a switch, two cascaded amplifiers, a baseband circuitry comprised of an ultra-low-power timer biasing at a constant rate the switch connecting the antennas to modulate the mm-wave signal and create a subcarrier; and a power source or battery.

In further aspects, an electronic device in accordance with the platform may comprise a portable electronic device configured to receive and track information signals from the disclosed wireless tags and display to a user various visual indicia and information associated with the tag to assist an end user in locating the tag. The electronic device may comprise at least one of: a wireless electronic headset, augmented reality (AR) headset, mixed reality (MR) headset, a handheld scanner, a smartphone, a wireless tablet, or combinations thereof, or the like. In still further aspects, the electronic device may comprise at least one display, at least one processing unit, and at least one radar unit. The processing unit may be operable communication with the radar unit and configured to process signals from the radar unit to enable localization of the tags.

The radar unit may comprise ranging and 1D and/or 2D angles of arrival (AoA) determination capabilities. The radar unit may be duty-cycled to reduce its average power consumption. In yet further aspects, the radar unit may comprise at least one transmitting (TX) array comprising a plurality of transmitting antennas, and at least one receiving (RX) array comprising a plurality of receiving antennas. The transmitting antennas may comprise at least 1 channel, and the receiving antennas may comprise at least 2 channels. In yet further aspects, the RX and TX antennas may be mutually cross-polarized. In even further aspects, the radar unit may comprise an electromagnetic band-gap (EBG) structure to reduce surface waves coupled from the TX antennas to the RX antennas and to, therefore, decrease the self-interference and increase the sensitivity of the receiver. In still further aspects, the wireless tags of the present platform that use higher frequencies and mm-wave radar, allow such antenna arrays to be incorporated into small form factor, lightweight, headset devices.

In further aspects, the display may be configured to display the generated visual indication and information associated with a target tag of interest. The display may comprise a see-through display, a heads-up display (HUD), an optical head-mounted display (OHMD), embedded wireless glasses with transparent heads-up display (HUD), augmented reality (AR) overlay, or the like.

In still further aspects, the electronic device may further comprise a wireless module configured to communicate with other devices on the platform, such as a remote server or central database. The wireless module may be an active wireless module (i.e., Wi-Fi or the like) configured to receive instructions from the remote server or central database. In yet further aspects, the electronic device may further comprise a scanning device or imaging unit configured to interpret or capture an object identifier attached to or associated with the object. The object identifier may comprise a visual label, text, barcode, UPS, EPC, QR code or the like.

In yet further aspects, the platform may comprise one or more input modules. In some embodiments, some or all of the components of input module may reside on or in the electronic device, such as the AR/VR headset. In other embodiments, some or all of the components of input modules may reside on or in a separate device. Input module may include one or more geo-positioning sensors or sensor devices. Non-limiting examples of geo-positioning sensors may include a GNSS (e.g., GPS) receiver and processing components, a magnetometer, a compass, or other suitable geo-positioning sensors. Input modules may include one or more inertial sensors or sensor devices. Non-limiting examples of inertial sensors include an accelerometer (e.g., a multi-axis accelerometer), a gyroscope, or other suitable inertial sensor devices or inertial measurement units (IMUs). To this end, wireless tags, geo-positioning sensors and/or the inertial sensors may be collectively used by the electronic device (e.g., an AR mobile device), the platform or other remote device to determine a six degree-of-freedom (6DOF) positioning of the electronic device within a three-dimensional space or environment. As used herein, 6DOF positioning may refer to a three-dimensional position (e.g., three translational coordinates; i.e., X, Y, Z values) and an orientation (e.g., three rotational angles; i.e., yaw, pitch, roll values) within a coordinate system. In further aspects, the electronic device (e.g., an AR mobile device) may utilize from 1 to 6 of the aforementioned six independent variables corresponding to 6DOF positioning values (i.e., from 1 DOF to 6 DOF) of tagged objects or landmarks in determining its 6DOF positioning in the three-dimensional space or environment.

In even further aspects, embodiments of the present disclosure may comprise methods, systems, and a computer readable medium comprising, but not limited to, at least one of the following: wireless tag, a portable or mobile electronic device, and/or a server or base station. Consistent with embodiments of the present disclosure, a method may be performed by at least one of the devices disclosed herein. The method may be embodied as, for example, but not limited to, computer instructions, which when executed, perform the method.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### Ii. Platform Configuration

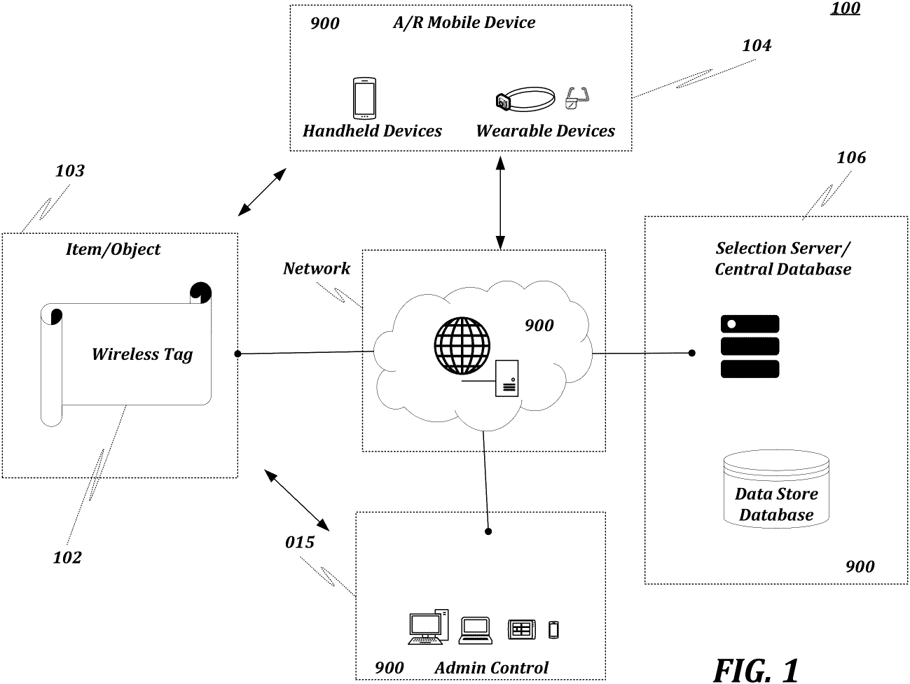

According to various aspects, embodiments of the present platform can comprise multiple configurations. FIGS. 1-9 illustrate non-limiting examples of embodiments of operating environments, devices, methods, mechanisms, and components for the disclosed platform. Although the operating environments, devices, methods, modules, mechanisms, and components are disclosed with specific functionality, it should be understood that functionality may be shared between mechanisms and/or components, with some functions split between mechanisms and/or components, while other functions duplicated by the mechanisms and/or components. Furthermore, the name of the devices, mechanisms and/or components should not be construed as limiting upon the functionality of the devices, mechanisms and/or components. Moreover, each stage or component in the claim language can be considered independently without the context of the other stages. Each component or stage may contain language defined in other portions of this specifications. Each component or stage disclosed for one mechanism and/or component may be mixed with the operational stages of another mechanism and/or component. Each component or stage can be claimed on its own and/or interchangeably with other stages of other mechanisms and/or components.

FIG. 1 illustrates one possible operating environment through which a platform 100 consistent with embodiments of the present disclosure may be provided. By way of non-limiting example, platform 100 may be hosted on, in part or fully, for example, but not limited to, a cloud computing service. In some embodiments, platform 100, or portions thereof, may be hosted on a computing device 900 or a plurality of computing devices. The various components of platform 100 may then, in turn, operate with wireless tags 102, for example, via localization engine 105, and one or more computing devices 900, such as mobile device 104. A user may access platform 100 through a software application and/or hardware device. The software application may be embodied as, for example, but not be limited to, a website, a web application, a desktop application, and/or a mobile application compatible with the computing device 900 or mobile device 104.

In some aspects, the platform may comprise a localization engine 105 (e.g., logic or software instructions) stored in a memory (ROM, RAM, etc., not shown) and executable by a processing or computational unit. In other aspects, the platform may comprise a localization engine 105 configured to process selections (e.g., items to be picked or a general task to be accomplished) received from one or more selection sources (e.g., a central database or server or user) for detection, localization, and output to a display. For example, the localization engine may also be configured to connect to networks, wireless tags, other platform devices, order fulfillment systems, and other user selection designations. In various further aspects, a user may specify one or more selection sources. To this end, Platform 100 may include one or more servers, central databases, or base stations, such as selection server 106. Selection server 106 may be in communication with one or more mobile devices and one or more wireless tags. Each selection server 106 may comprise hardware and/or software used to store and/or communicate selections, instructions, and general information to one or more mobile devices (e.g., the mobile device 104) and/or one or more wireless tags 102. In some embodiments, the selection server 106 may include hardware and/or software for communicating or designating a tag or tagged target object for selection. In other embodiments, the selection server 106 may receive data and transmit new selections and/or instructions to one or more other devices or wireless tags. For example, the selection server 106 may receive a communication or other data from mobile device 104 indicating that a target object associated with a wireless tag has been picked or task completed. The server may then transmit instructions to said wireless tag to turn off signal transmission. To this end, mobile device 104 may transmit, to the selection server 106 completion of retrieval of an object or item and/or a request for a new selection.

In various further aspects, embodiments of wireless tag 102 and mobile device 104 may include one or more additional or alternative components, elements, units, modules, engines, and/or devices. In some embodiments, one or more of the components, modules, units, elements, processes and/or devices of wireless tag 102 and mobile device 104 may be combined, divided, re-arranged or omitted. As such, wireless tag 102 and mobile devices 104 may comprise at least one or more of those architectural components as found in computing device 900. Accordingly, embodiments of the present disclosure provide a software and hardware platform comprised of a distributed set of computing elements, including, but not limited to: one or more wireless tags 102 associated with a target object or item 103 and one or more mobile devices 104, and, in some embodiments, one or more selection servers 106.

In further aspects, platform 100 may include one or more wireless tags 102. Wireless tag 102 may be generally equipped with equipped with a high-frequency (e.g., 24 GHz+) backscatter front-end including an antenna system and switches. The antenna system is generally comprised of a cross-polarizing retrodirective antenna array to allow the detection of the tags at extended ranges. The switches on the tag may be controlled by a modulator which can be a low-power processor/ASIC/FPGA or an ultra-low-power timer/oscillator controlled by a processor/ASIC/FPGA. In further aspects, the modulation of the switches can allow wireless tag to modulate its radar cross section (RCS) and to create a recognizable synthetic signature for the radar unit of the mobile device 104. In some embodiments, wireless tag does not generate any electromagnetic wave to enable its localization. In further aspects, wireless tag may have a battery, a circuit enabling its wireless powering, or an energy-harvesting circuit. Wireless tag may also be equipped with a conventional wireless transceiver that allows it to wirelessly communicate but is not involved in the localization process.

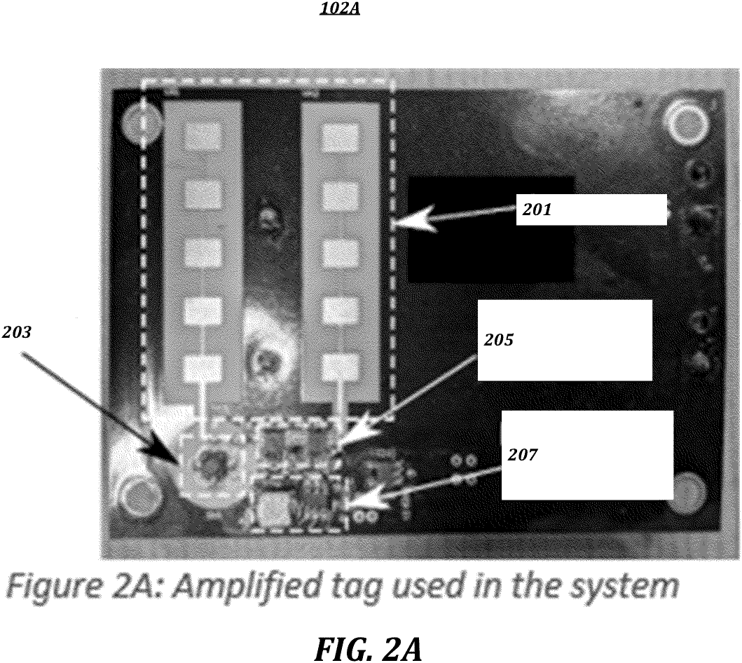

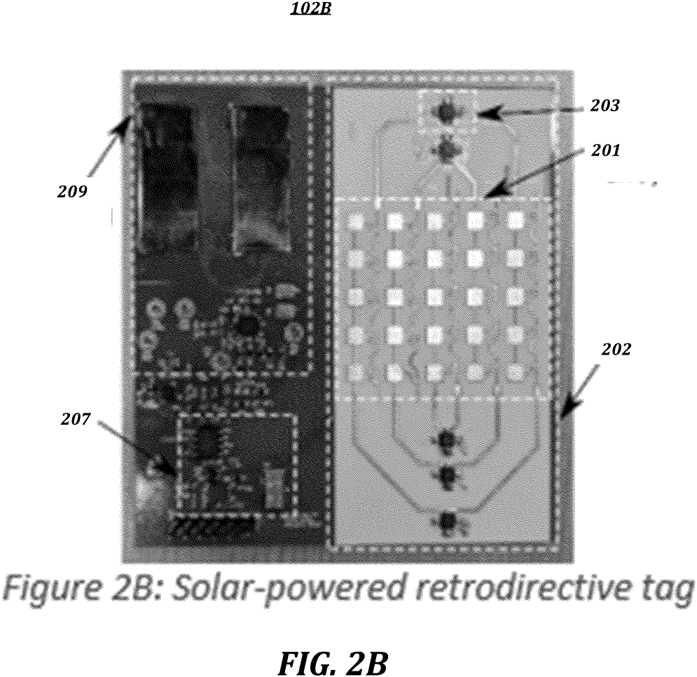

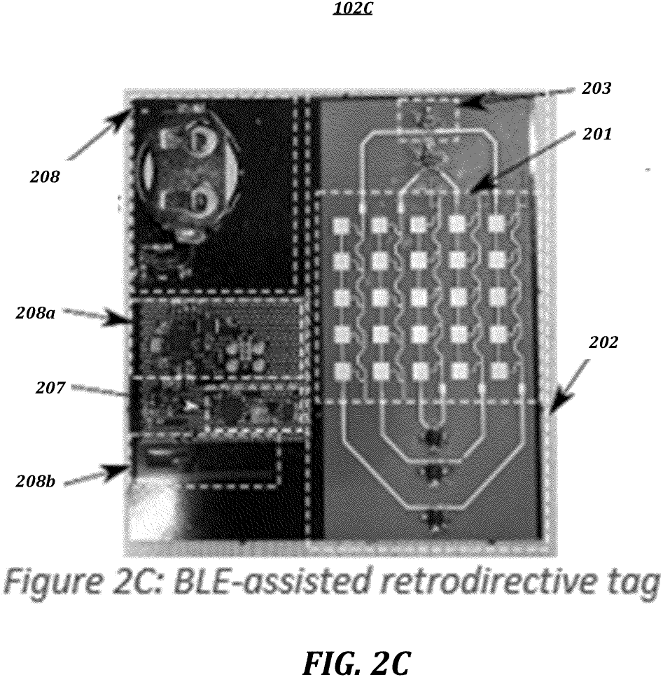

In various aspects, FIGS. 2A-2C are diagrams of illustrative wireless tags 104 in accordance with example embodiments of the present platform. Wireless tags generally include a RX antenna, a TX antenna, and a line connecting the antennas with a switch and cascaded amplifiers, baseband circuitry comprised of an ultra-low-power timer biasing at a constant rate the switch connecting the antennas to modulate the mm-wave signal and create a subcarrier, and power source, such as a battery.

FIG. 2A is a diagram of an amplified tag 102A comprising antennas 201 (one RX antenna, one TX antenna), a line connecting the antennas 201 with an RF switch 203 and two cascaded RF amplifiers 205, and a modulating oscillator 207 comprised of an ultra-low-power timer biasing at a constant rate the switch connecting the antennas to modulate the mm-wave signal and create a subcarrier. FIG. 2B is a diagram of solar-powered retrodirective tag 102B comprising antenna array 201, retrodirective backscatter array system 202, RF switch 203, modulating oscillator 207, and solar power harvesting and management subsystem 209. FIG. 2C is a BLE-assisted retrodirective tag 102C comprising antenna array 201, retrodirective backscatter array subsystem 202, RF switch 203, modulating oscillator 207, BLE transceiver 208a, BLE antenna 208b, and energy storage and management subsystem 209.

In further aspects, the wireless tags, while being localized, may consume less than 10 µW (compared to the 100 mW of UWB) and can be detected at ranges over 200 m (compared to 10 m for RFID). In still further aspects, the wireless tags may be duty cycled while they are not being localized, enabling the disclosed tags to run for a decade or longer, even under heavy use. The wireless tags can be made ultra-thin and wrapped around any material without compromising their radiation performance, unlike RFID (whose performance degrades heavily in the presence of metal). Still further, the wireless tags can be used with a disclosed mobile device which may comprise an 8 cm x 6 cm reader capable of measuring AoAs with better than a few degrees of accuracy while consuming less than 100 mW of power. Accordingly, the present platform can-in real-time-provide accurate situational awareness to an AR system while consuming little power and without requiring the constant maintenance of the tags that enable it.

In various further aspects, platform 100 may include one or more mobile devices 104. Each mobile device 104 may comprise hardware and/or software used to effect detection and visual localization of a wireless tag of interest to a user. In embodiments, mobile device 104 may comprise one or more of a wireless electronic headset, augmented reality (AR) headset or glasses, mixed reality (MR) headset or glasses, a handheld scanner, a smartphone, a wireless tablet, and/or any other computing device configured to permit detection and visual presentation of a localized wireless tag. AR mobile device 104 may configured to receive or retrieve general information or metadata. The received general information or metadata may comprise information related to a wireless tag associated with an object or item to be located and procured within the user’s environment. For example, the information may comprise information related to the identity or general location of the tag or target object.

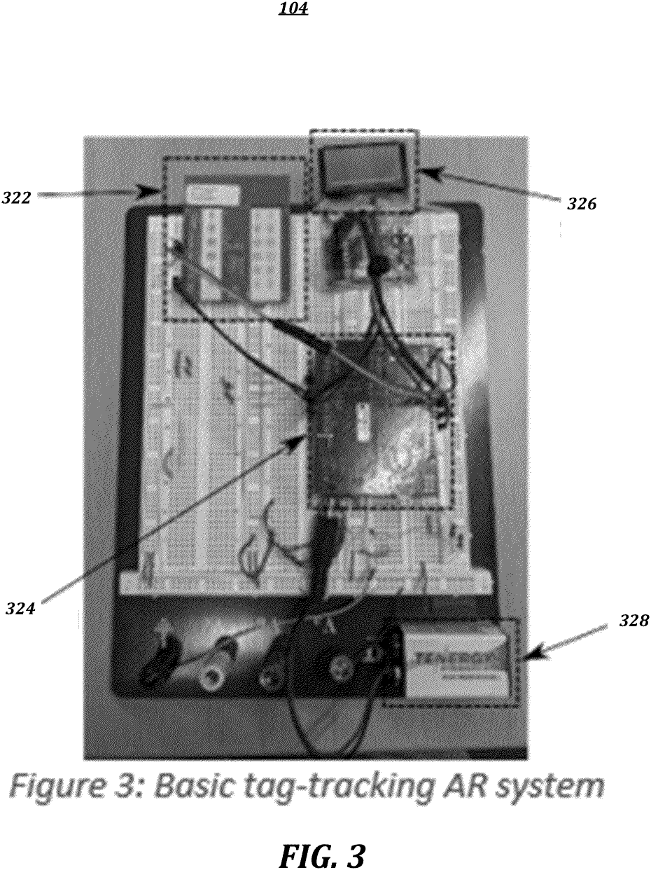

FIG. 3 is a diagram of an AR mobile device 104 for tag tracking in accordance with example embodiment of the present platform. According to the various embodiments, alternative configurations of AR mobile device 104 may include one or more additional or alternative components, elements, units, modules, engines, and/or devices. In some embodiments, one or more of the components, modules, units, elements, processes and/or devices of the AR mobile device 104 may be combined, divided, re-arranged or omitted. As such, mobile devices 104 may comprise at least one or more of those architectural components as found in computing device 900.

As shown in FIG. 3, AR mobile device 104 generally includes a radar unit 322, a computational unit 324, a display 326, such as a see through display, and a power source 328, such as a battery. Radar unit 322 may comprise a high-frequency radar module matching the frequency of the wireless tag, such as a frequency-modulated continuous-wave (FMCW) 24-24.25 GHz radar module, including: one TX antenna, two RX antennas, one transceiver, baseband amplifying circuitry, and an on-board signal-processing and control module. For example, the AR mobile device may comprise an FMCW 24-24.25 GHz radar module including: a TX antenna, multiple RX antennas, a transceiver, baseband amplifying circuitry; an on-board signal-processing and control module; an Arduino; and a see-through OLED display.

AR mobile device may further comprise or otherwise be employed with a head mount. The head mount may be configured to a head of a user, such as for example, a worker that may view a visual indication of a localized target tag. In further aspects, the visual indication or overlay may comprise various visual media components (e.g., graphics, images, etc.) and/or audio media components. Graphics data may be representative of, for example, text, graphics and/or augmented reality elements (e.g., graphics or information overlaid on objects within the field of view). The graphics data may be one or more graphics to be displayed to users at locations that correspond to target tags, objects, or landmarks identified in a warehouse or retail environment.

In further aspects, AR device may be configured to generate graphics or images in any desired direction, orientation, size, color, and/or pattern corresponding to a particular location in a field of view and thus corresponding to a particular focal distance based on the location of the target tag or object. The generated graphic or image may be different from another to distinguish different objects from the target object. As described herein, the display may be see-through or transparent may be transparent such that the user can view surroundings simultaneously with the generated graphic or image forming an augmented reality view, or the surroundings only when no graphic is overlayed or displayed.

In some aspects, the AR device may comprise an audio module configured to receive and/or transmit audio data. The audio data may be converted and transmitted to the user as sound via an earphone jack and/or a speaker. In some embodiments, the AR device may be configured to generate both audio and visual elements, such as providing a visual indication and an audio indication of the location of target items identified in the environment. In other aspects, the AR device may comprise one or more sensors, including but not limited to a light sensor, motion sensor (e.g., an accelerometer), gyroscope, accelerometer, or the like. In further aspects, the visual indication generated may be affected by one or more measurements of one or more sensors. For example, a characteristic of the visual indication may depend on the output of the sensors, such, as the color, size, and/or animation of the image.

In further aspects. The mobile device or display may be employed as a number of various augmented reality displays. For example, in some embodiments, the display may be implemented as a heads-up display (HUD) unit, such as wireless AR glasses with one (monocular) or two (binocular) see-through displays. In other embodiments, the mobile device may be implemented as a portable handheld device, such as a handheld scanner.

In some embodiments, the mobile device may comprise a capture unit or module. The capture unit may be mounted to employed in the AR mobile device. In other embodiments, the capture unit may be in a companion mobile device carried by the user, such as a smartphone. The capture unit may include one or more cameras and/or a microphone configured to capture visual image data and/or audio data, respectively, representative of an environment surrounding the AR device. In further aspects, the image data of the environment can then be used by the platform, for example to confirm an item was picked or task completed or augment include images identifying the location of items in the environment.

In further aspects, various data may be communicated by the AR device to a server or base station, such as through an interface unit or layer, such as a wired or wireless interface. The interface unit may be configured to communicate completion of a task or successful location of a target item within the environment. The server or base station may represent multiple devices, including workstations, keypads, access points, and mobile computing devices, as well servers. The servers may include or be part of order fulfillment or inventory management system, or the like. The servers may communicate with or AR devices for designating target tags for detection and/or identifying other landmarks within an inventory environment.

In further aspects, the radar unit may comprise a wireless tag reader for detecting and identifying objects of interest in an inventory environment, in particular, by identifying a wireless tag associated with each target object of interest. As described herein, the radar unit may include an antenna configured to emit a radiation pattern configured to extend over an effective reading range within an inventory environment to identify and read one or more wireless tags. In further aspects, the platform instructs the radar unit to identify only designated wireless tags, such as wireless tags corresponding to objects or items selected by a central database or selection server. The target objects may be items identified in a pick list, such as for a customer purchase or for shipping. For example, the selection server may communicate wireless tag data associated with the target object to the AR mobile device over the network, and communicate that wireless tag data to the radar unit to search for the corresponding wireless tag and alert the mobile device when the wireless tag has been identified.

To this end, the radar unit detects and determines a location of the identified wireless tags, for example by determining signal strength of an RFID signal from the wireless tag and/or using phase data provided by the wireless tag. The location information and target tag information are processed to then generate a visual indication to identify the location of the wireless tag to the user, in particular to identify the location or bin position of the wireless tag in an augmented reality display.

In various embodiments, a mobile device may be configured to detect and transmit data to a localization engine 105 for processing. As described herein, mobile devices may be comprised of a multitude of devices, such as, but not limited to, a viewing device that is configured to receive and transmit radio, graphical, optical, audio, and/or telemetry data. Localization engine 105 may configured to, for example, receive from tags associated with an object for locating, perform detection and localization techniques on the tags, and provide a visual indication 405 of the target tag or object. In some embodiments, localization engine 105 may be configured to provide an interface layer and a data store layer for enabling input data streams to localization engine 105, as well as an output provision to a display, third party systems and user devices from localization engine 105.

In further aspects, embodiments of the present disclosure provide a localization engine 105, within a software and/or hardware platform, comprised of a set of modules. In some embodiments, the modules may be distributed. The modules may comprise, but not limited to: an input module; identification module; and an analysis module. In other embodiments, the present disclosure may provide an additional set of modules for further facilitating the software and/or hardware platform. The additional set of modules may comprise, but not be limited to: interface layer; and data store layer.

The aforementioned modules and functions and operations associated therewith may be operated by mobile device 104, a computing device 900, or a plurality of computing devices 900. In some embodiments, each module may be performed by separate, networked computing devices 900; while in other embodiments, certain modules may be performed by the same computing device 900 or cloud environment. Though the present disclosure is written with reference to a centralized computing device 900 or cloud computing service, it should be understood that any suitable computing device 900 may be employed to provide the various embodiments disclosed herein. Input module may be responsible for receiving and/or inputting of selections or instruction for designating a target tag for detection to localization engine 105. The selection may be used to, for example, designate a target tag or object for detection and tracking. The input selection may be in various forms received either directly or indirectly from a server or base station.

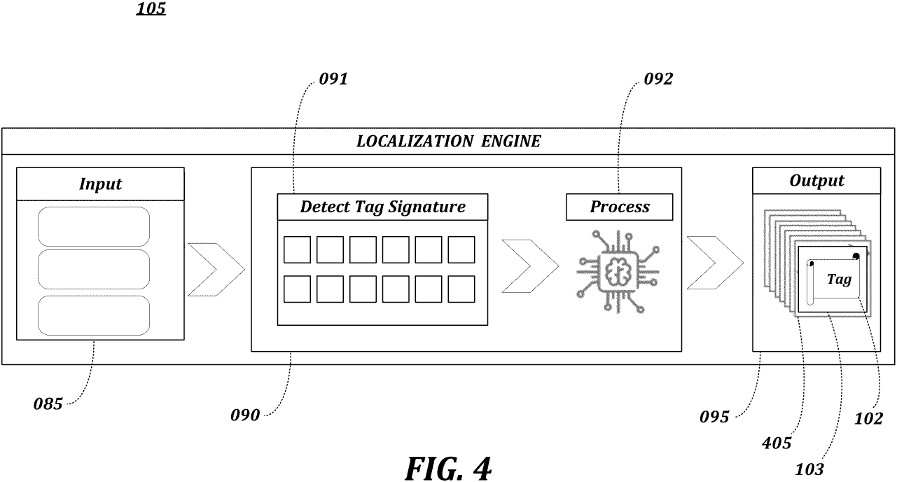

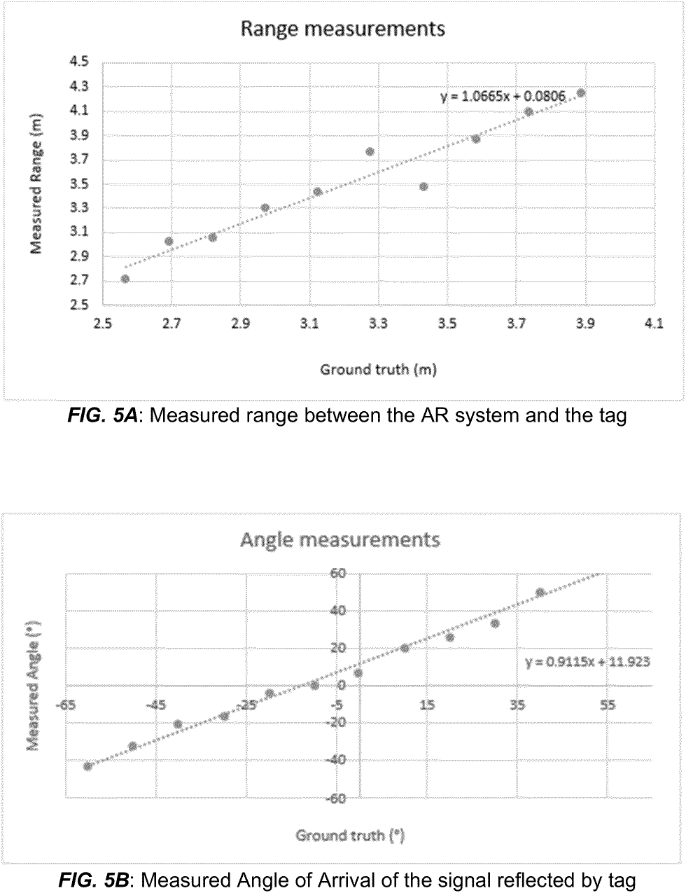

FIG. 4 illustrates one example of a localization engine 105 architecture for performing detection and localization of a wireless tag associated with an object of interest in an environment. In various aspects, the architecture may be comprised of, but not limited to, an input stage 085, a detection, tracking, and analysis stage 090, and an output stage 095. Accordingly, localization engine 105 may receive or retrieve data from a selection server or input module during an input stage. The selection may then be processed in accordance to the target object designation associated with the selection. The target object designation may be based on, for example, but not limited to, the object with which a wireless tag is associated. Upon receiving the selection, localization engine 105 may proceed to detection, tracking, and analysis stage 090. In this stage, localization engine 105 may employ the given selection and process the selection through, for example, detection of electromagnetic signature associated with the tagged target objects and determination of the tagged target object’s location. In this way, localization engine may, for example, using the radar unit, detect the subcarrier created by the tag modulation using a filter and a peak-detection algorithm. In further aspects, the modulation peaks in positive and negative frequency spaces may be detected and their frequencies compared to extract the beat frequency produced by the FMCW process and the range between the tag and the radar unit. An example of the benchmarking of such measurements is shown in FIG. 5A. The phase difference between the signal received by the two RX antennas may be used to determine the Angle of Arrival of this signal and to, therefore, estimate the direction of the tag (i.e., azimuth only in this embodiment). An example of the benchmarking of such measurements is shown in FIG. 5B. By way of non-limiting example, detection, tracking, and analysis stage 090 may perform algorithms for analyzing detected tags and objects within the environment for various spatial parameters, visual cues, object curvatures, geo-locations, and other parameters that may correspond to the localization of the target tag. In this way, target objects may be identified within the environment. Having detected and localized a target tag, localization engine 105 may proceed to output stage 095. The output may be, for example, visual or graphical data about the target object sent to a display or interface layer. In some embodiments, the output may be when, for example, the user looks for the location/bin of the target object/item, general information about the object’s position displayed on the display. As the user gets close enough to the tag associated with the target object, a display may indicate the direction of the tag relative to the field of view with arrows (if the tag is in a direction outside of the user’s field of view) and then overlays a marker or visual indication showing the position of the item once it enters the FOV, such as a box around the target object as shown in output stage 095. In further aspects, the output may be accompanied by a range estimate or other spatial parameter information.

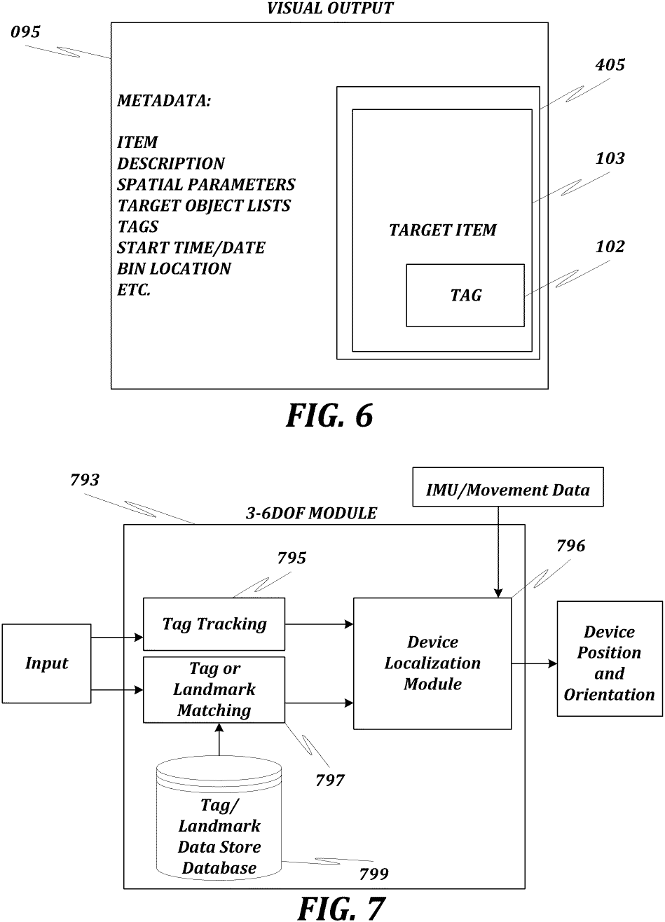

FIG. 6 is a block diagram of output stage 095 illustrating how one or more visual indication 405 may be graphically associated with a localized target tag 102 on a display. Visual indication 405 may be a graphic or image overlayed target item 103 with tag 102 and may be accompanied with other data associated with the item of interest. The visual indication 405 may be labeled, and include other identifiers associated with the item 103 including but not limited to: item description, one or more spatial parameters, item number on selection list, bin location, a date, start-time, end-time, duration, and orientation data, and the like. Output stage 095 may be presented within an AR view in the form of AR content, including AR target objects and landmarks. Each of these AR objects may include a multi-dimensional graphical object (e.g., a two or three-dimensional object) having a six degree-of-freedom (6DOF) positioning (e.g., X, Y, Z values within a coordinate system) and/or orientation (e.g., yaw, pitch, roll values within a coordinate system) within AR view.

In various embodiments, the platform may comprise a 6DOF localization module for determining position and orientation of AR mobile device and/or tracking AR mobile device movement relative to tagged landmarks and/or objects of interest in the environment. By knowing how fixed tagged landmarks are set up in an environment (i.e. configuration) and measuring one’s position and orientation relative to them can be used to determine one’s 6DOF position in a space or environment. To this end, the platform can use the measured positions of these tagged landmarks or objects and their known configuration to calculate the position and orientation (i.e., pose) of the AR mobile device in a 3-D space or environment. For example, and without limitation, the AR mobile device can use at least 1 of 6 independent variables corresponding to 6DOF positioning values (i.e., from 1 DOF to 6 DOF) of tagged landmarks or objects in determining its own 6DOF positioning in the three-dimensional space or environment. In some embodiments, the AR mobile device can use 1, 2, 3, 4, 5, or 6 independent variables corresponding to 6DOF positioning values (i.e., from 1 DOF to 6 DOF) of tagged landmarks or objects in determining its own 6DOF positioning.

FIG. 7 is a block diagram of an example 3-6DOF module 793 for localization of an AR mobile device in the disclosed platform. The 6DOF localization module 793 may comprise a tag tracker 795 for detecting tagged landmarks and objects and determining its positioning, orientation, and/or configuration within an environment, a landmark matcher 797 for matching and/or retrieving configuration data of landmarks and target objects, and a searchable database 799, which may include stored configuration data of known landmarks and objects. In further aspects, the 3-6DOF module 793 may also include a device localization module 796 to calculate the AR device’s position and/or orientation (i.e., 6DOF positioning) within the environment using extracted or calculated configuration data of tagged landmark and objects. The configuration data can comprise geographic location, position, and orientation information, including 1, 2, 3, 4, 5, or 6 independent variables for 6DOF positioning (i.e., from 1 DOF to 6 DOF). In still further aspects, the IMU/movement data output from an AR mobile device movement sensor (e.g., IMUs embedded in or integrated with the AR mobile device) may be used to assist determining the AR device’s position, orientation, and/or pose.

In some embodiments, the configuration data (i.e. 1 or more 6DOF positioning values of tagged landmark or object) without the need for AR device IMU/movement data (i.e., geo-positioning/inertial sensor data) may be sufficient to determine the position, orientation, and/or pose of the AR device, and/or otherwise present AR overlays upon and/or align with the tagged objects in the environment. In other embodiments, the IMU/movement data for the AR device may be used by the platform in conjunction with the configuration data to assist in determining 6DOF positioning of the AR device within the environment. In yet further aspects, the configuration data may comprise 1, 2, 3, 4, 5, or 6 independent variables corresponding to 6DOF positioning values (i.e., from 1 DOF to 6 DOF) of tagged landmarks or objects. Each of the disclosed stages, engines, modules and/or data structures may be implemented in software, hardware, firmware, or a combination thereof, e.g., as units of computer code implemented using a programming language such as Java, C++, or Python, and/or data structures and stored in computer memory (e.g., non-transitory machine readable media).

### III. Platform Operation and Methods for Use

Also disclosed herein are methods for using the disclosed platform. In further aspects, the present platform allows for a wide range of uses related to localization-based detection and tracking of wireless tags in an environment. For example, in one aspect, the wireless tag may be used to track the location of a target object, such as item or product in a warehouse or retail environment. Thus, according to the present platform, if a target object is designated to be picked for an order, a user may be able to locate the wireless tags associated with target object within the warehouse or retail environment using an AR headset, handheld scanner, or another suitable device. In further aspects, the present platform (system, devices, methods and techniques) allows distance, position, location, and/or orientation determinations with a high degree of accuracy. For example, an AR mobile device of the present platform may be capable of determining the location of a wireless tag to an accuracy within 2 meters, 1 meter, one foot, or 6 inches or less.

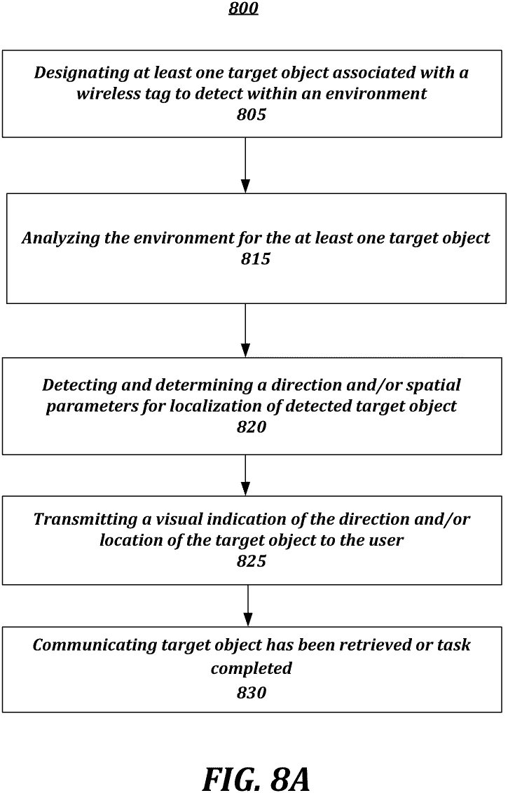

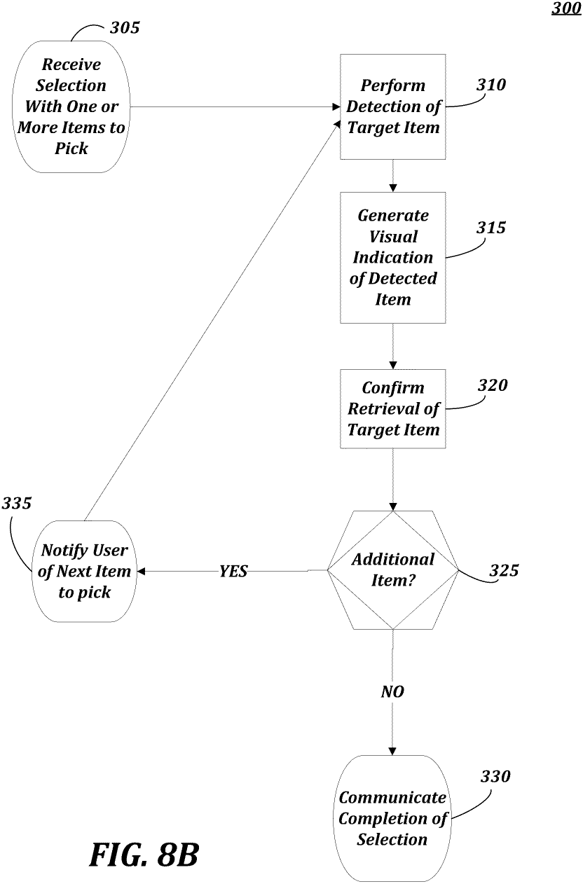

FIGS. 8A-8B are flow charts setting forth various stages involved in methods consistent with embodiments of the disclosure for using the disclosed platform. Methods 800 and 300 may be implemented using, at least in part, for example, wireless tags 102, mobile devices 104, computing device 900, as described in more detail with respect to FIGS. 1-9.

Method 800 in FIG. 8A may begin at starting block 805, where platform 100 designates at least one target object 103 associated with a wireless tag 102 to detect within an environment for the user to pick or retrieve. If the wireless tags are not continuously left ON, the wireless tags which need to be localized are wirelessly instructed to turn ON their RCS modulation. The modulation may occur at an assigned frequency (FM), which is associated with the tag for a given period and allows its identification.

From stage 805, where the target wireless tag is designated and activated within the environment, method 800 may proceed to stage 815 where the environment will be analyzed for the target wireless tag of interest. For example, mobile device 104 activates its radar, which sends out an electromagnetic wave in most directions (e.g., quasi-isotropically) or with directivity but combined with a scanning process to cover most directions/locations.

From stage 815, where the electromagnetic wave is transmitted by the radar unit, method 800 may proceed to stage 820 where concurrently, the radar detects the modulated reflected signature of the target tag and determines its range, for example, using an FMCW beat-frequency extraction or a more general TOF process. In further aspects, the modulated signature can also enable the identification of the tag. In still further aspects, the radar may also use several antennas and receiving (RX) channels to determine the directions of arrival (DOA) of the signal. In even further aspects, the radar may combine this with the use of several transmitting antennas and channels (TX) to reduce the number of required antennas and/or to achieve better angular localization performance (e.g., MIMO, or the like).

From stage 820, where the target tag of interest has been detected and localized, method 800 may proceed to stage 825 where a visual indication of the direction and/or location of the target tag may be generated and transmitted to the user. In further aspects, a device of mobile device 104 may display part or all of the acquired position data and/or a visual marker to the user of the platform. In still further aspects, since the position of the tag is directly determined in a nearly-identical coordinate system as that of the display, this process may require minimal processing and computing. In even further aspects, additional contextual information may be displayed as well (e.g., an instructional video related to the localized item, once the user arrives close enough to it, for instance).

From stage 825, where a visual indication of the direction and/or location of the target tag is displayed to the user, method 800 may proceed to stage 830, where the user may retrieve the target item and/or complete the task and communicate completion to the platform. To this end, once it has been communicated (using a manual input or behavioral queues) that the user is done interacting with the item associated with the current tag, the tag may be instructed to turn OFF its modulation to save power. After stage 830, method 800 may end. In further aspects, a user may follow method 800 to localize and retrieve a target item for multiple items at various locations within the environment as desired.

In further embodiments, Method 300 in FIG. 8B may begin at starting block 305, where platform 100, for example from a server or base station, transmits a selection (e.g., pick list) designating one or more items to be picked, for example, 2 or more items. If the first target tag is equipped with an active transceiver, a central base-station may also send a communication to activate the backscattering of the tag. From stage 305, where the first target item from the selection is designated and activated within the environment, method 300 may proceed to stage 310 where the radar detects the modulated reflected signature of the target tag and determines its range.

From stage 310, where the target tag of interest has been detected and localized, method 300 may proceed to stage 315 where a visual indication of the direction and/or location of the target tag may be generated and transmitted to the user. In further aspects, when the user (e.g., a picker or storer) looks for the location/bin of the item, general information about the item’s position may also be displayed on the display of the system, such as shown in FIG. 6. As the user gets close enough to the tag associated with the item, a display may indicate the direction of the tag relative to the field of view with arrows (if the tag is in a direction outside of the user’s field of view) and then overlays a marker, such as visual indication 405, showing the position of the item once it enters the FOV. Other data associated with the item may also be displayed, such as a range estimate and the like.

From stage 825, where a visual indication of the direction and/or location of the target item is displayed to the user, method 300 may proceed to stage 320, where the user may retrieve the target item and/or complete the task and communicate completion to the platform. For example, the user may accomplish their task and use an input method to communicate the completion of the task to the central system. To this end, once it has been communicated that the user is done interacting with the item associated with the current tag, the central server may instruct the tag associated with the first item to turn OFF its modulation to save power. After stage 330, method 300 may proceed to stage 325 to determine if additional items remain to be picked from the selection or pick list. If further items remain to be retrieved, stage 325 may proceed to stage 335, where the user if notified of the next item, and returns to stage 310 to complete the detection and retrieval of the next item. If no further items remain to be retrieved, stage 325 may proceed to stage 330 where completion of the entire selection or pick list may be communicated, for example, to a central server or base station. Method 300 may then begin again with transmission of a new selection or pick list to the user.

### IV. Computing Device Architecture

Embodiments of the present disclosure provide a hardware and software platform operative as a distributed system of modules and computing elements. In further aspects, elements of platform 100 may be implemented by hardware, software, firmware, and/or any combination of hardware, software and/or firmware. In some embodiments, one or more of the elements is implemented by a logic circuit. As used herein, the term “logic circuit” is defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations. Some example logic circuits are hardware that executes machine-readable instructions to perform operations. Some example logic circuits include a combination of specifically configured hardware and hardware that executes machine-readable instructions.

In still further aspects, platform 100 may be embodied as, for example, but not be limited to, a website, a web application, a desktop application, backend application, and a mobile application compatible with a mobile device 104 or a computing device 900. The computing device 900 may comprise, but not be limited to the following:

Mobile computing device, such as, but is not limited to, a laptop, a tablet, a smartphone, a drone, a wearable, an embedded device, a handheld device, an Arduino, an industrial device, or a remotely operable recording device; A supercomputer, an exa-scale supercomputer, a mainframe, or a quantum computer; A minicomputer, wherein the minicomputer computing device comprises, but is not limited to, an IBM AS400 / iSeries / System I, A DEC VAX / PDP, a HP3000, a Honeywell-Bull DPS, a Texas Instruments TI-990, or a Wang Laboratories VS Series; A microcomputer, wherein the microcomputer computing device comprises, but is not limited to, a server, wherein a server may be a rack mounted server, a blade server, an appliance-based computing resource, an accelerator card (such as those manufactured by Xilinx or Intel), a workstation, an industrial device, a raspberry pi, a desktop, or an embedded device; A purpose-built computing device, wherein the purpose-built computing device comprises hardware and/or software custom designed for a specific deployment environment and/or usage scenario, such as a computing device for use in a satellite or other communication device.

Embodiments of platform 100 may be hosted on a centralized server or a cloud computing service. Although methods have been described to be performed by mobile device 104 or computing device 900, it should be understood that, in some embodiments, different operations may be performed by a plurality of the computing devices 900 in operative communication over one or more networks.

Embodiments of the present disclosure may comprise a system having a central processing unit (CPU) 920, a bus 930, a memory unit 940, a power supply unit (PSU) 950, and one or more Input / Output (I/O) units. The CPU 920 coupled to the memory unit 940 and the plurality of I/O units 960 via the bus 930, all of which are powered by the PSU 950. It should be understood that, in some embodiments, each disclosed unit may actually be a plurality of such units for the purposes of redundancy, high availability, and/or performance. The combination of the presently disclosed units is configured to perform the stages any method disclosed herein.

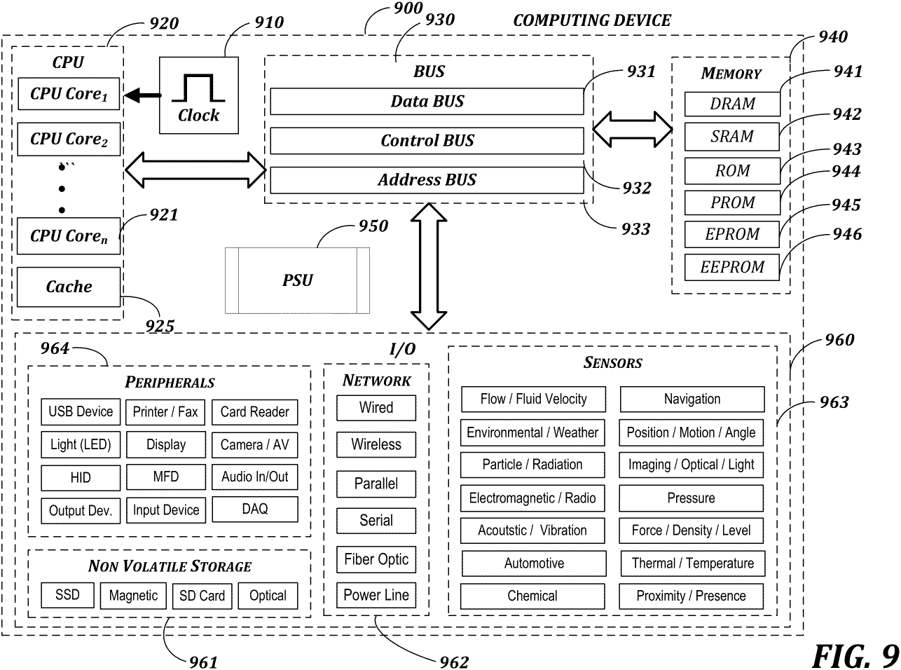

FIG. 9 is a block diagram of a system including computing device 900. Consistent with an embodiment of the disclosure, the aforementioned CPU 920, the bus 930, the memory unit 940, a PSU 950, and the plurality of I/O units 960 may be implemented in a computing device, such as computing device 900 of FIG. 22. Any suitable combination of hardware, software, or firmware may be used to implement the aforementioned units. For example, the CPU 920, the bus 930, and the memory unit 940 may be implemented with computing device 900 or any of other computing devices 900, in combination with computing device 900. The aforementioned system, device, and components are examples and other systems, devices, and components may comprise the aforementioned CPU 920, the bus 930, the memory unit 940, consistent with embodiments of the disclosure.

One or more computing devices 900 may be embodied as any of the computing elements illustrated in FIGS. 1-7, including, but not limited to, wireless tags, mobile devices, localization engine, recognition module, selection module, detection module, tracking module, analysis module, data store, interface layer such as user and admin interfaces, and the like.. A computing device 900 does not need to be electronic, nor even have a CPU 920, nor bus 930, nor memory unit 940. The definition of the computing device 900 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 900, especially if the processing is purposeful.

With reference to FIG. 9, a system consistent with an embodiment of the disclosure may include a computing device, such as computing device 900. In a basic configuration, computing device 900 may include at least one clock module 910, at least one CPU 920, at least one bus 930, and at least one memory unit 940, at least one PSU 950, and at least one I/O 960 module, wherein I/O module may be comprised of, but not limited to a non-volatile storage sub-module 961, a communication sub-module 962, a sensors sub-module 963, and a peripherals sub-module 964.

A system consistent with an embodiment of the disclosure the computing device 900 may include the clock module 910 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 920, the central component of modern computers, which relies on a clock. The only exceptions are asynchronous circuits such as asynchronous CPUs. The clock 910 can comprise a plurality of embodiments, such as, but not limited to, single-phase clock which transmits all clock signals on effectively 1 wire, two-phase clock which distributes clock signals on two wires, each with nonoverlapping pulses, and four-phase clock which distributes clock signals on 4 wires.

Many computing devices 900 use a “clock multiplier” which multiplies a lower frequency external clock to the appropriate clock rate of the CPU 920. This allows the CPU 920 to operate at a much higher frequency than the rest of the computer, which affords performance gains in situations where the CPU 920 does not need to wait on an external factor (like memory 940 or input/output 960). Some embodiments of the clock 910 may include dynamic frequency change, where, the time between clock edges can vary widely from one edge to the next and back again.

A system consistent with an embodiment of the disclosure the computing device 900 may include the CPU unit 920 comprising at least one CPU Core 921. A plurality of CPU cores 921 may comprise identical the CPU cores 921, such as, but not limited to, homogeneous multi-core systems. It is also possible for the plurality of CPU cores 921 to comprise different the CPU cores 921, such as, but not limited to, heterogeneous multi-core systems, big.LITTLE systems and some AMD accelerated processing units (APU). The CPU unit 920 reads and executes program instructions which may be used across many application domains, for example, but not limited to, general purpose computing, embedded computing, network computing, digital signal processing (DSP), and graphics processing (GPU). The CPU unit 920 may run multiple instructions on separate CPU cores 921 at the same time. The CPU unit 920 may be integrated into at least one of a single integrated circuit die and multiple dies in a single chip package. The single integrated circuit die and multiple dies in a single chip package may contain a plurality of other aspects of the computing device 900, for example, but not limited to, the clock 910, the CPU 920, the bus 930, the memory 940, and I/O 960.

The CPU unit 921 may contain cache 922 such as, but not limited to, a level 1 cache, level 2 cache, level 3 cache or combination thereof. The aforementioned cache 922 may or may not be shared amongst a plurality of CPU cores 921. The cache 922 sharing comprises at least one of message passing and inter-core communication methods may be used for the at least one CPU Core 921 to communicate with the cache 922. The inter-core communication methods may comprise, but not limited to, bus, ring, two-dimensional mesh, and crossbar. The aforementioned CPU unit 920 may employ symmetric multiprocessing (SMP) design.

The plurality of the aforementioned CPU cores 921 may comprise soft microprocessor cores on a single field programmable gate array (FPGA), such as semiconductor intellectual property cores (IP Core). The plurality of CPU cores 921 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 921, for example, but not limited to Instruction-level parallelism (ILP) such as, but not limited to, superscalar pipelining, and Thread-level parallelism (TLP).

Consistent with the embodiments of the present disclosure, the aforementioned computing device 900 may employ a communication system that transfers data between components inside the aforementioned computing device 900, and/or the plurality of computing devices 900. The aforementioned communication system will be known to a person having ordinary skill in the art as a bus 930. The bus 930 may embody internal and/or external plurality of hardware and software components, for example, but not limited to a wire, optical fiber, communication protocols, and any physical arrangement that provides the same logical function as a parallel electrical bus. The bus 930 may comprise at least one of, but not limited to a parallel bus, wherein the parallel bus carry data words in parallel on multiple wires, and a serial bus, wherein the serial bus carry data in bit-serial form. The bus 930 may embody a plurality of topologies, for example, but not limited to, a multidrop / electrical parallel topology, a daisy chain topology, and a connected by switched hubs, such as USB bus. The bus 930 may comprise a plurality of embodiments, for example, but not limited to:
Internal data bus (data bus) 931 / Memory bus
Control bus 932
Address bus 933
System Management Bus (SMBus)
Front-Side-Bus (FSB)
External Bus Interface (EBI)
Local bus
Expansion bus
Lightning bus
Controller Area Network (CAN bus)
Camera Link
ExpressCard

Advanced Technology management Attachment (ATA), including embodiments and derivatives such as, but not limited to, Integrated Drive Electronics (IDE) / Enhanced IDE (EIDE), ATA Packet Interface (ATAPI), Ultra-Direct Memory Access (UDMA), Ultra ATA (UATA) / Parallel ATA (PATA) / Serial ATA (SATA), CompactFlash (CF) interface, Consumer Electronics ATA (CE-ATA) / Fiber Attached Technology Adapted (FATA), Advanced Host Controller Interface (AHCI), SATA Express (SATAe) / External SATA (eSATA), including the powered embodiment eSATAp / Mini-SATA (mSATA), and Next Generation Form Factor (NGFF) / M.2.
Small Computer System Interface (SCSI) / Serial Attached SCSI (SAS)
HyperTransport
InfiniBand
RapidIO
Mobile Industry Processor Interface (MIPI)
Coherent Processor Interface (CAPI)
Plug-n-play
1-Wire

Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (i.e., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt / Mini DisplayPort, Mobile PCIe (M-PCIe), U.2, and Non-Volatile Memory Express (NVMe) / Non-Volatile Memory Host Controller Interface Specification (NVMHCIS).

Industry Standard Architecture (ISA) including embodiments such as, but not limited to Extended ISA (EISA), PC/XT-bus / PC/AT-bus / PC/104 bus (e.g., PC/104-Plus, PCI/104-Express, PCI/104, and PCI-104), and Low Pin Count (LPC).

### Music Instrument Digital Interface (MIDI)

Universal Serial Bus (USB) including embodiments such as, but not limited to, Media Transfer Protocol (MTP) / Mobile High-Definition Link (MHL), Device Firmware Upgrade (DFU), wireless USB, InterChip USB, IEEE 1394 Interface / Firewire, Thunderbolt, and eXtensible Host Controller Interface (xHCI).

Consistent with the embodiments of the present disclosure, the aforementioned computing device 900 may employ hardware integrated circuits that store information for immediate use in the computing device 900, know to the person having ordinary skill in the art as primary storage or memory 940. The memory 940 operates at high speed, distinguishing it from the non-volatile storage sub-module 961, which may be referred to as secondary or tertiary storage, which provides slow-to-access information but offers higher capacities at lower cost. The contents contained in memory 940, may be transferred to secondary storage via techniques such as, but not limited to, virtual memory and swap. The memory 940 may be associated with addressable semiconductor memory, such as integrated circuits consisting of silicon-based transistors, used for example as primary storage but also other purposes in the computing device 900. The memory 940 may comprise a plurality of embodiments, such as, but not limited to volatile memory, non-volatile memory, and semi-volatile memory. It should be understood by a person having ordinary skill in the art that the ensuing are non-limiting examples of the aforementioned memory: Volatile memory which requires power to maintain stored information, for example, but not limited to, Dynamic Random-Access Memory (DRAM) 941, Static Random-Access Memory (SRAM) 942, CPU Cache memory 925, Advanced Random-Access Memory (A-RAM), and other types of primary storage such as Random-Access Memory (RAM). Non-volatile memory which can retain stored information even after power is removed, for example, but not limited to, Read-Only Memory (ROM) 943, Programmable ROM (PROM) 944, Erasable PROM (EPROM) 945, Electrically Erasable PROM (EEPROM) 946 (e.g., flash memory and Electrically Alterable PROM [EAPROM]), Mask ROM (MROM), One Time Programable (OTP) ROM / Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory. Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 900 may employ the communication system between an information processing system, such as the computing device 900, and the outside world, for example, but not limited to, human, environment, and another computing device 900. The aforementioned communication system will be known to a person having ordinary skill in the art as I/O 960. The I/O module 960 regulates a plurality of inputs and outputs with regard to the computing device 900, wherein the inputs are a plurality of signals and data received by the computing device 900, and the outputs are the plurality of signals and data sent from the computing device 900. The I/O module 960 interfaces a plurality of hardware, such as, but not limited to, non-volatile storage 961, communication devices 962, sensors 963, and peripherals 964. The plurality of hardware is used by the at least one of, but not limited to, human, environment, and another computing device 900 to communicate with the present computing device 900. The I/O module 960 may comprise a plurality of forms, for example, but not limited to channel I/O, port-mapped I/O, asynchronous I/O, and Direct Memory Access (DMA).

Consistent with the embodiments of the present disclosure, the aforementioned computing device 900 may employ the non-volatile storage sub-module 961, which may be referred to by a person having ordinary skill in the art as one of secondary storage, external memory, tertiary storage, off-line storage, and auxiliary storage. The non-volatile storage sub-module 961 may not be accessed directly by the CPU 920 without using intermediate area in the memory 940. The non-volatile storage sub-module 961 does not lose data when power is removed and may be two orders of magnitude less costly than storage used in memory module, at the expense of speed and latency. The non-volatile storage sub-module 961 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (961) may comprise a plurality of embodiments, such as, but not limited to:

Optical storage, for example, but not limited to, Compact Disk (CD) (CD-ROM / CD-R / CD-RW), Digital Versatile Disk (DVD) (DVD-ROM / DVD-R / DVD+R / DVD-RW / DVD+RW / DVD±RW / DVD+R DL / DVD-RAM / HD-DVD), Blu-ray Disk (BD) (BD-ROM / BD-R / BD-RE / BD-R DL / BD-RE DL), and Ultra-Density Optical (UDO).

Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, and Solid State Drive (SSD) and memristor.

Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD)
Molecular Memory
Deoxyribonucleic Acid (DNA) digital data storage

Consistent with the embodiments of the present disclosure, the aforementioned computing device 900 may employ the communication sub-module 962 as a subset of the I/O 960, which may be referred to by a person having ordinary skill in the art as at least one of, but not limited to, computer network, data network, and network. The network allows computing devices 900 to exchange data using connections, which may be known to a person having ordinary skill in the art as data links, between network nodes. The nodes comprise network computer devices 900 that originate, route, and terminate data. The nodes are identified by network addresses and can include a plurality of hosts consistent with the embodiments of a computing device 900. The aforementioned embodiments include, but not limited to personal computers, phones, servers, drones, and networking devices such as, but not limited to, hubs, switches, routers, modems, and firewalls.

Two nodes can be said are networked together, when one computing device 900 is able to exchange information with the other computing device 900, whether or not they have a direct connection with each other. The communication sub-module 962 supports a plurality of applications and services, such as, but not limited to World Wide Web (WWW), digital video and audio, shared use of application and storage computing devices (900), printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN / Wi-Fi), Internet Protocol (IP) suite (e.g., TCP/IP, UDP, Internet Protocol version 4 [IPv4], and Internet Protocol version 6 [IPv6]), Synchronous Optical Networking (SONET) / Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 962 may comprise a plurality of size, topology, traffic control mechanism and organizational intent. The communication sub-module 962 may comprise a plurality of embodiments, such as, but not limited to:
Wired such as, but not limited to, coaxial cable, phone lines, twisted pair cables (ethernet), and InfiniBand.
Wireless communications such as, but not limited to, communications satellites, cellular systems, radio frequency / spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMax and LTE), and 5G.
Parallel communications such as, but not limited to, LPT ports
Serial communications such as, but not limited to, RS-232 and USB
Fiber Optic communications such as, but not limited to, Single-mode optical fiber (SMF) and Multi-mode optical fiber (MMF).
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 900 may employ the sensors sub-module 963 as a subset of the I/O 960. The sensors sub-module 963 comprises at least one of the devices, modules, and subsystems whose purpose is to detect events or changes in its environment and send the information to the computing device 900. Sensors are sensitive to the measured property, are not sensitive to any property not measured, but may be encountered in its application, and do not significantly influence the measured property. The sensors sub-module 963 may comprise a plurality of digital devices and analog devices, wherein if an analog device is used, an Analog to Digital (A-to-D) converter must be employed to interface the said device with the computing device 900. The sensors may be subject to a plurality of deviations that limit sensor accuracy. The sensors sub-module 963 may comprise a plurality of embodiments, such as, but not limited to, chemical sensors, automotive sensors, acoustic / sound / vibration sensors, electric current / electric potential / magnetic / radio sensors, environmental / weather / moisture / humidity sensors, flow / fluid velocity sensors, ionizing radiation / particle sensors, navigation sensors, position / angle / displacement / distance / speed / acceleration sensors, imaging / optical / light sensors, pressure sensors, force / density / level sensors, thermal / temperature sensors, and proximity / presence sensors. It should be understood by a person having ordinary skill in the art that the ensuing are non-limiting examples of the aforementioned sensors:

Chemical sensors such as, but not limited to, breathalyzer, carbon dioxide sensor, carbon monoxide / smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).

Automotive sensors such as, but not limited to, air flow meter / mass airflow sensor, air-fuel ratio meter, AFR sensor, blind spot monitor, engine coolant / exhaust gas / cylinder head / transmission fluid temperature sensor, hall effect sensor, wheel / automatic transmission / turbine / vehicle speed sensor, airbag sensors, brake fluid / engine crankcase / fuel / oil / tire pressure sensor, camshaft / crankshaft / throttle position sensor, fuel /oil level sensor, knock sensor, light sensor, MAP sensor, oxygen sensor (o2), parking sensor, radar sensor, torque sensor, variable reluctance sensor, and water-in-fuel sensor.

Acoustic, sound and vibration sensors such as, but not limited to, microphone, lace sensor (guitar pickup), seismometer, sound locator, geophone, and hydrophone.

Electric current, electric potential, magnetic, and radio sensors such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.

Environmental, weather, moisture, and humidity sensors such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.

Flow and fluid velocity sensors such as, but not limited to, air flow meter, anemometer, flow sensor, gas meter, mass flow sensor, and water meter.

Ionizing radiation and particle sensors such as, but not limited to, cloud chamber, Geiger counter, Geiger-Muller tube, ionization chamber, neutron detection, proportional counter, scintillation counter, semiconductor detector, and thermoluminescent dosimeter.

Navigation sensors such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.

Position, angle, displacement, distance, speed, and acceleration sensors such as, but not limited to, accelerometer, displacement sensor, flex sensor, free fall sensor, gravimeter, impact sensor, laser rangefinder, LIDAR, odometer, photoelectric sensor, position sensor such as GPS or Glonass, angular rate sensor, shock detector, ultrasonic sensor, tilt sensor, tachometer, ultra-wideband radar, variable reluctance sensor, and velocity receiver.

Imaging, optical and light sensors such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.

Pressure sensors such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.

Force, Density, and Level sensors such as, but not limited to, bhangmeter, hydrometer, force gauge / force sensor, level sensor, load cell, magnetic level / nuclear density / strain gauge, piezocapacitive pressure sensor, piezoelectric sensor, torque sensor, and viscometer.

Thermal and temperature sensors such as, but not limited to, bolometer, bimetallic strip, calorimeter, exhaust gas temperature gauge, flame detection / pyrometer, Gardon gauge, Golay cell, heat flux sensor, microbolometer, microwave radiometer, net radiometer, infrared / quartz / resistance thermometer, silicon bandgap temperature sensor, thermistor, and thermocouple.

Proximity and presence sensors such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 900 may employ the peripherals sub-module 962 as a subset of the I/O 960. The peripheral sub-module 964 comprises ancillary devices uses to put information into and get information out of the computing device 900. There are 3 categories of devices comprising the peripheral sub-module 964, which exist based on their relationship with the computing device 900, input devices, output devices, and input / output devices. Input devices send at least one of data and instructions to the computing device 900. Input devices can be categorized based on, but not limited to:

Modality of input such as, but not limited to, mechanical motion, audio, and visual.

Whether the input is discrete, such as but not limited to, pressing a key, or continuous such as, but not limited to position of a mouse.

The number of degrees of freedom involved such as, but not limited to, two-dimensional mice vs three-dimensional mice used for Computer-Aided Design (CAD) applications.

Output devices provide output from the computing device 900. Output devices convert electronically generated information into a form that can be presented to humans. Input /output devices perform that perform both input and output functions. It should be understood by a person having ordinary skill in the art that the ensuing are non-limiting embodiments of the aforementioned peripheral sub-module 964:

### Input Devices

Human Interface Devices (HID), such as, but not limited to, pointing device (e.g., mouse, touchpad, joystick, touchscreen, game controller / gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).

High degree of freedom devices, that require up to six degrees of freedom such as, but not limited to, camera gimbals, Cave Automatic Virtual Environment (CAVE), and virtual reality systems.

Video Input devices are used to digitize images or video from the outside world into the computing device 900. The information can be stored in a multitude of formats depending on the user’s requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner, and the like.

Audio input devices are used to capture sound. In some cases, an audio output device can be used as an input device, in order to capture produced sound. Audio input devices allow a user to send audio signals to the computing device 900 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.

Data AcQuisition (DAQ) devices covert at least one of analog signals and physical parameters to digital values for processing by the computing device 900. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:

Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, and Refreshable Braille Display / Braille Terminal.

Printers such as, but not limited to, inkjet printers, laser printers, 3D printers, and plotters.

Audio and Video (AV) devices such as, but not limited to, speakers, headphones, and lights, which include lamps, strobes, DJ lighting, stage lighting, architectural lighting, special effect lighting, and lasers.

### Other Devices Such as Digital to Analog Converter (DAC)

Input / Output Devices may further comprise, but not be limited to, touchscreens, networking device (e.g., devices disclosed in network 962 sub-module), data storage device (non-volatile storage 961), facsimile (FAX), and graphics / sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

The present invention includes at least the following aspects: Aspect 1: A system for providing a visual indication associated with an electromagnetically or radio frequency identification (RFID) tagged target object in a physical environment of a user, the system comprising: a portable electronic device comprising a display, a processing unit, and a radar unit; the system configured to: receive information signals from at least one wireless tag connected to or associated with at least one target object or object location in a physical environment of a user, and generate a visual indication associated with the tagged target object based at least on the received information signals, said visual indication at least having information corresponding to the object’s location or position. Aspect 2: The system of any preceding aspect, wherein the system comprises at least one wireless tag. Aspect 3: The system of any preceding aspect, wherein the system comprises a plurality of wireless tags. Aspect 4: The system of any preceding aspect, wherein the wireless tag comprises a radio frequency identification (RFID) tag. Aspect 5: The system of any preceding aspect, wherein the RFID tag comprises an antenna system comprising one or more antennas. Aspect 6: The system of any preceding aspect, wherein the RFID tag antenna system comprises individual antennas, instead of linear arrays, to make the system more compact. Aspect 7: The system of any preceding aspect, wherein the RFID tag antenna system comprises a 2D array of individual antennas. Aspect 8: The system of any preceding aspect, wherein the RFID tag 2D individual antenna array may be connected in as taught by US6657580B1. Aspect 9: The system of any preceding aspect, wherein the RFID tag antenna system comprises a retrodirective array. Aspect 10: The system of any preceding aspect, wherein the RFID tag antenna system is generally comprised of a cross-polarizing retrodirective antenna array effective to allow the detection of the tags at extended ranges. Aspect 11: The system of any preceding aspect, wherein the RFID tag antenna system is configured to re-emit at least a portion of impinging signals back in a polarization state that is orthogonal to that of an original signal. Aspect 12: The system of any preceding aspect, wherein the RFID tag comprises a front-end system comprising one or more phase-shifters and/or switches configured to modulate phase and magnitude of a backscattered signal. Aspect 13: The system of any preceding aspect, wherein the RFID tag comprises a high-frequency (24 GHz+) backscatter front-end system comprising an antenna system and/or switches. Aspect 14: The system of any preceding aspect, wherein the RFID tag comprises an ultra-low-power modulator circuit configured to control the front-end system effective to shape the backscattered signal. Aspect 15: The system of any preceding aspect, wherein the RFID tag switches are configured to be controlled by a modulator which can be a low-power processor/ASIC/FPGA or an ultra-low-power timer/oscillator controlled by a processor/ASIC/FPGA. Aspect 16: The system of any preceding aspect, wherein the modulator circuit may comprise an ultra-low-power timer operating at a frequency between about 100 Hz and 10 MHz. Aspect 17: The system of any preceding aspect, wherein the RFID tag comprises an ultra-low-power computational unit. Aspect 18: The system of any preceding aspect, wherein the RFID tag computational unit is configured to also serve as a modulator. Aspect 19: The system of any preceding aspect, wherein the modulation of the RFID switches is configured to allow the RFID tag to modulate a Radar Cross Section (RCS) effective to create a recognizable synthetic signature for the radar of the device. Aspect 20: The system of any preceding aspect, wherein the RFID tag does not generate any electromagnetic wave to enable its localization. Aspect 21: The system of any preceding aspect, wherein the RFID tag comprises at least one of: a battery, a circuit enabling wireless powering, or an energy-harvesting circuit, or combinations thereof. Aspect 22: The system of any preceding aspect, wherein the RFID tag comprises a battery or supercapacitor. Aspect 23: The system of any preceding aspect, wherein the RFID tag comprises an energy harvesting system comprising a solar cell or another converter of ambient energy. Aspect 24: The system of any preceding aspect, wherein the RFID tag comprises an E-ink display for use as a standard label. Aspect 25: The system of any preceding aspect, wherein the RFID tag comprises a wireless transceiver. Aspect 26: The system of any preceding aspect, wherein the RFID tag wireless transceiver comprises an active wireless transceiver used to reprogram the RFID tag. Aspect 27: The system of any preceding aspect, wherein the RFID tag wireless transceiver comprises any desired wireless communication standards including but not limited to Wi-Fi, BLE, or NFC, or the like. Aspect 28: The system of any preceding aspect, wherein the RFID tag wireless transceiver is configured to wireless communication without involvement in a localization process. Aspect 29: The system of any preceding aspect, wherein the RFID tag is configured to be continuously left ON or OFF. Aspect 30: The system of any preceding aspect, wherein when the RFID tag is not on, the tag which need to be localized are wirelessly instructed to turn ON their RCS modulation. Aspect 31: The system of any preceding aspect, wherein the RFID tag modulation is configured to occur at an assigned frequency (FM), which is associated with the tag for a given period effective to allow its identification. Aspect 32: The system of any preceding aspect, wherein the RFID tag is configured to substitute or complement traditional product labels at the picking position/bin associated with each item. Aspect 33: The system of any preceding aspect, wherein the RFID tag is configured to use a frequency higher than the 900 MHz ISM band. Aspect 34: The system of any preceding aspect, wherein the RFID tags is configured to use a frequency greater than 5.8 GHz. Aspect 35: The system of any preceding aspect, wherein the RFID tags is configured to use a frequency greater than 8 GHz. Aspect 36: The system of any preceding aspect, wherein the RFID tags is configured to use a frequency greater than 24 GHz. Aspect 37: The system of any preceding aspect, wherein the portable electronic device comprises at least one of: a smartphone, a wireless tablet, a wireless electronic headset, augmented reality (AR) headset, mixed reality (MR) headset, or combinations thereof, or the like. Aspect 38: The system of any preceding aspect, wherein the radar unit comprises ranging and 1D and/or 2D angles of arrival (AoA) determination capabilities. Aspect 39: The system of any preceding aspect, wherein the radar unit comprises at least one transmitting (TX) array comprising a plurality of transmitting antennas, and at least one receiving (RX) array comprising a plurality of receiving antennas. Aspect 40: The system of any preceding aspect, wherein the transmitting antennas comprises at least 1 channel. Aspect 41: The system of any preceding aspect, wherein the receiving antennas comprise at least 2 channels. Aspect 42: The system of any preceding aspect, wherein the RX and TX antennas may be mutually cross-polarized. Aspect 43: The system of any preceding aspect, wherein radar unit may comprise an electromagnetic band-gap (EBG) structure to reduce surface waves coupled from the TX antennas to the RX antennas and to, therefore, decrease the self-interference and increase the sensitivity of the receiver. Aspect 44: The system of any preceding aspect, wherein the radar unit may be duty-cycled to reduce its average power consumption. Aspect 45: The system of any preceding aspect, wherein the processing unit is operable communication with the radar unit and configured to process signals from the radar unit to enable localization of the tags. Aspect 46: The system of any preceding aspect, further configured to display the generated visual indication on the display. Aspect 47: The system of any preceding aspect, wherein the display comprises a heads-up display (HUD,) an optical head-mounted display (OHMD), an embedded wireless glasses with transparent heads-up display (HUD), augmented reality (AR) overlay, or a see-through display. Aspect 48: The system of any preceding aspect, further comprising a wireless module configured to communicate with a remote server or central database. Aspect 49: The system of any preceding aspect, wherein the active wireless module (i.e., Wi-Fi or the like) is configured to receive instructions from the remote server or central database. Aspect 50: The system of any preceding aspect, wherein the portable electronic device may comprise a scanning device or imaging unit configured to interpret or capture an object identifier attached to or associated with the object. Aspect 51: The system of any preceding aspect, wherein the object identifier comprises a visual label, text, barcode, UPS, EPC, QR code or the like. Aspect 52: The system of any preceding aspect, wherein the system is configured to communicate with a central database/management system or remote server. Aspect 53: The system of any preceding aspect, wherein the central database system is configured communicate information with the system, such as, for example, to send picking order and receive event information to and from the portable electronic device of the user.

Aspect 54: A method for a providing an augmented visual indication associated with a wireless tag in a physical environment of a user, the method comprising the steps of: designating at least one wireless tag associated with a target object for detection from among a plurality of tags within an environment; detecting the at least one tagged target object within the environment; determining a direction for locating and/or location the at least one tagged target object; and providing a visual indication of the direction and/or location of the at least one tagged target object. Aspect 55: The system or method of any preceding aspect, wherein designating comprises receiving instructions or selection of the at least one wireless tag associated with a target object for detection from a central server or database. Aspect 56: The system or method of any preceding aspect, wherein the physical environment is a warehouse or retail environment. Aspect 57: The system or method of any preceding aspect, wherein the tagged object is a predetermined tagged product selected from an inventory comprising a plurality of products. Aspect 58: The system or method of any preceding aspect, wherein the tagged object is a predetermined tagged landmark in the physical environment. Aspect 59: The system or method of any preceding aspect, wherein a six-degree-of-freedom (6DOF) positioning of the mobile device is determined based at least in part on measured positions and known configurations of a tagged object or tagged landmark. Aspect 60: The system or method of any preceding aspect, wherein a six-degree-of-freedom (6DOF) positioning of the mobile device is determined based at least in part on 6DOF positioning of a tagged object or tagged landmark. Aspect 61: The system or method of any preceding aspect, wherein a six-degree-of-freedom (6DOF) positioning of the mobile device is determined based at least in part on at least one variable of 6DOF positioning of a tagged object or tagged landmark. Aspect 62: The system or method of any preceding aspect, wherein the at least one variable of 6DOF positioning is selected from X, Y, or Z values within a coordinate system or yaw, pitch, or roll values within a coordinate system.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications may be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1) A system for providing a visual indication associated with an electromagnetically or radio frequency identification (RFID) tagged target object in a physical environment of a user, the system comprising:
a portable electronic device comprising a display, a processing unit, and a radar unit; the system configured to:
receive information signals from at least one wireless tag connected to or associated with at least one target object or object location in a physical environment of a user, and
generate a visual indication associated with the tagged target object based at least on the received information signals, said visual indication at least having information corresponding to the object’s location or position.

2) The system of claim 1, further comprising at least one radio frequency identification (RFID) tag including an antenna system comprising at least one 2D array of individual antennas.

3) The system of claim 2, wherein the RFID tag antenna system comprises a retrodirective array.

4) The system of claim 2, wherein the RFID tag antenna system is configured to re-emit at least a portion of impinging signals back in a polarization state that is orthogonal to that of an original signal.

5) The system of claim 2, wherein the RFID tag comprises a front-end system comprising one or more phase-shifters and switches configured to modulate phase and magnitude of a backscattered signal.

6) The system of claim 4, wherein the RFID tag comprises a 24 GHz+ or higher frequency backscatter front-end system comprising the antenna system and one or more antenna switches; and an ultra-low-power modulator circuit configured to control the front-end system effective to shape a backscattered signal.

7) The system of claim 6, wherein the RFID tag comprises at least one of: a battery, a circuit enabling wireless powering, or an energy-harvesting circuit, or combinations thereof.

8) The system of claim 7, wherein the RFID tag comprises an E-ink display for use as a standard label.

9) The system of claim 8, wherein the RFID tag comprises a wireless transceiver comprises an active wireless transceiver configured to reprogram the RFID tag.

10) The system of claim 7, wherein the portable electronic device comprises at least one of: a smartphone, a wireless tablet, a wireless electronic headset, augmented reality (AR) headset, mixed reality (MR) headset, or combinations thereof.

11) The system of claim 10, wherein the radar unit comprises ranging and 1D and/or 2D angles of arrival (AoA) determination capabilities.

12) The system of claim 10, wherein the radar unit comprises at least one transmitting (TX) array comprising a plurality of transmitting antennas, and at least one receiving (RX) array comprising a plurality of receiving antennas.

13) A system for providing an augmented visual indication associated with a radio frequency identification (RFID) tagged target object in a physical environment, the system comprising:
a portable electronic device comprising a display, a processing unit, and a radar unit comprising at least one transmitting (TX) array including a plurality of transmitting antennas, and at least one receiving (RX) array including a plurality of receiving antennas; the system configured to:
receive information signals from at least one wireless tag connected to or associated with at least one target object or object location in a physical environment of a user, and
generate a visual indication associated with the tagged target object based at least on the received information signals, said visual indication at least having information corresponding to the object’s location or position; and
a plurality of radio frequency identification (RFID) tags, each RFID tag comprising:
an antenna system including at least one cross-polarizing retrodirective antenna array,
an active wireless transceiver configured to reprogram the RFID tag, and at least one of: a battery, a circuit enabling wireless powering, or an energy-harvesting circuit, or combinations thereof,
the RFID tag antenna system configured to re-emit at least a portion of impinging signals back in a polarization state that is orthogonal to that of an original signal and use a frequency greater than 24 GHz.

14) The system of claim 13, wherein the RFID tag comprises a front-end system comprising one or more phase-shifters and switches configured to modulate phase and magnitude of a backscattered signal.

15) The system of claim 14, wherein the RFID tag comprises a high-frequency (24 GHz+) backscatter front-end system comprising the antenna system and one or more antenna switches; and an ultra-low-power modulator circuit configured to control the front-end system effective to shape a backscattered signal.

16) The system of claim 15, wherein the portable electronic device comprises at least one of: a smartphone, a wireless tablet, a wireless electronic headset, augmented reality (AR) headset, mixed reality (MR) headset, or combinations thereof; and wherein the radar unit comprises ranging and 1D and/or 2D angles of arrival (AoA) determination capabilities.

17) A method for a providing an augmented visual indication associated with a wireless RFID tag in a physical environment of a user, the method comprising the steps of:
designating at least one wireless tag associated with a target object for detection from among a plurality of RFID tags within an environment;
detecting the at least one tagged target object within the environment;
determining a direction for locating and/or location the at least one tagged target object; and
providing an augmented visual indication of the direction and/or location of the at least one tagged target object.

18) The method of claim 17, wherein designating comprises receiving instructions or selection of the at least one wireless tag associated with a target object for detection from a central server or database; and wherein providing the augmented visual indication comprises outputting the augmented visual indication on a display of a mobile device.

19) The method of claim 18, wherein the wireless RFID tag comprises an antenna system configured to re-emit at least a portion of impinging signals back in a polarization state that is orthogonal to that of an original signal; wherein the wireless RFID tag comprises a front-end system comprising one or more phase-shifters and switches configured to modulate phase and magnitude of a backscattered signal; and wherein the wireless RFID tag uses a 24 GHz+ or higher frequency backscatter front-end system.

20) The method of claim 19, wherein the RFID tag comprises an ultra-low-power modulator circuit configured to control the front-end system effective to shape the backscattered signal; and wherein the RFID tag switches are configured to be controlled by a modulator which can be a low-power processor/ASIC/FPGA or an ultra-low-power timer/oscillator controlled by a processor/ASIC/FPGA.
